(19) United States
(12) Patent Application Publication
(10) Pub. No.: US 2023/0342799 A1
(43) Pub. Date: Oct. 26, 2023

(54) GENERATING SEGMENTS OF USERS BASED ON UNOBSERVED BEHAVIORS

(71) Applicant: Adobe Inc., San Jose, CA (US)

(72) Inventors: Aurghya Maiti, Kolkata (IN); Atanu R Sinha, Bangalore (IN); Harshita Chopra, New Delhi (IN); Sarthak Kapoor, New Delhi (IN); Atishay Ganesh, Bengaluru (IN); Saili Myana, Hyderabad (IN); Saurabh Mahapatra, Sunnyvale, CA (US)

(21) Appl. No.: 17/660,544

(22) Filed: Apr. 25, 2022

(51) Int. Cl. G06N 3/08; G06Q 30/02; G06N 3/04

(52) U.S. Cl. CPC G06Q 30/0204; G06N 3/0454; G06N 3/08; G06Q 30/0202

(57) ABSTRACT

The present disclosure relates to systems, non-transitory computer-readable media, and methods for incorporating unobserved behaviors when generating user segments or predictions of future user actions. In particular, in one or more embodiments, the disclosed systems utilize a deep learning-based clustering algorithm that segments the behavioral history of users based on a future outcome. Further, the disclosed systems recognize that users may exhibit behaviors that represent two or more segments and allow for targeted marketing to users based on the user’s inclusion in multiple segments.

### BACKGROUND

Recent years have seen significant improvements in targeted marketing based on users’ activities and interaction dynamics within a digital environment. For example, through cookies and other tracking means, conventional systems often have ready access to behavior logs of users’ actions/behaviors with digital environments (e.g., webpages or native software applications). This allows conventional systems to segment the users into meaningful groups and provide targeted marketing based on the detected behaviors. However, users’ behaviors and outcomes, such as when a user performs a desired action in response to targeted materials, are often influenced by actions/behaviors performed by the users outside the view of conventional targeting systems. Furthermore, behaviors can be hidden from conventional targeting systems when performed within a digital environment if a user did not log into the system or if the user deletes cookies. Conventional targeting systems suffer from these drawback, along with additional problems.

### BRIEF SUMMARY

Embodiments of the present disclosure provide benefits and/or solve one or more of the foregoing or other problems in the art with systems, non-transitory computer-readable media, and methods for estimating unobserved behaviors of users and utilizing the estimated unobserved behaviors together with the observed behavior to segment and/or target users. For instance, the disclosed systems estimate unobserved behaviors to model offline behaviors, behaviors on other websites, or behaviors on the same site but performed outside the marketer’s view. The unobserved behavior based segmentation and targeting system utilizes a deep learning-based segmentation and prediction algorithms that segment or predict a future outcome based on the observed and unobserved behaviors. The unobserved behavior segmentation and targeting system further recognizes that user segmentation is imprecise and utilizes deep learning-based clustering algorithm that generates a distribution over clusters or segments to accommodate the reality that users can fall into multiple segments. The unobserved behavior segmentation and targeting system utilizes the distribution to allow for mixed targeting of users across more than one segment.

Additional features and advantages of one or more embodiments of the present disclosure are outlined in the description which follows, and in part will be obvious from the description, or may be learned by the practice of such example embodiments.

### BRIEF DESCRIPTION OF THE DRAWINGS

This disclosure describes one or more embodiments with additional specificity and detail by referencing the accompanying figures, as briefly described below.

FIG. 1 illustrates a diagram of an environment in which an unobserved behavior segmentation and targeting system operates in accordance with one or more embodiments.

FIG. 2 illustrates a schematic diagram of incorporating unobserved behavior to make targeted predictions in accordance with one or more embodiments.

FIG. 3 illustrates a diagram of an unobserved behavior segmentation and targeting system accessing observed behavior in accordance with one or more embodiments.

FIG. 4 illustrates a diagram of generating unobserved behavior in accordance with one or more embodiments.

FIG. 5 illustrates a diagram of incorporating unobserved behavior when generating user segments in accordance with one or more embodiments.

FIG. 6 illustrates a diagram of an example encoder for encoding observed and unobserved behavior in accordance with one or more embodiments.

FIG. 7 illustrates a diagram of performing mixed targeting in accordance with one or more embodiments.

FIG. 8 illustrates a diagram of example probabilities of users belonging to multiple user segments in accordance with one or more embodiments.

FIGS. 9-10 illustrate diagrams of example performances of an unobserved behavior segmentation and targeting system in accordance with one or more embodiments.

FIG. 11 illustrates a schematic diagram of an example architecture of an unobserved behavior segmentation and targeting system in accordance with one or more embodiments.

FIG. 12 illustrates a flowchart of a series of acts of incorporating unobserved behaviors when predicting future behavior or segmenting users in accordance with one or more embodiments.

FIG. 13 illustrates a flowchart of a series of acts of segmenting users based on a probability distribution over user segments in accordance with one or more embodiments.

FIG. 14 illustrates a flowchart of a series of acts of incorporating unobserved behaviors and utilizing boosting when predicting future behavior or segmenting users in accordance with one or more embodiments.

FIG. 15 illustrates a block diagram of an example computing device for implementing one or more embodiments of the present disclosure.

### DETAILED DESCRIPTION

This disclosure describes one or more embodiments of an unobserved behavior segmentation and targeting system that utilizes a deep learning-based model that incorporates unobserved behaviors when performing user segmentation and/or prediction of future actions. For instance, in one or more embodiments, the unobserved behavior segmentation and targeting system injects unobserved behaviors into observed analytics data and utilizes deep learning to generate one or more of user segments or a probability that a user or segment of users will perform a target action. Moreover, when generating user segments, the unobserved behavior segmentation and targeting system relaxes conventional mutual exclusivity of segments and allows users to belong to more than one segment.

To illustrate, in one or more embodiments, the unobserved behavior segmentation and targeting system accesses observed analytics data (e.g., behaviors a user or users performed or learned attributes). In addition, the unobserved behavior segmentation and targeting system generates unobserved analytics data (e.g., behaviors/attributes not observed or learned). Moreover, the unobserved behavior segmentation and targeting system combines the observed analytics data and the generated unobserved analytics data into a combined observed-unobserved vector. The unobserved behavior segmentation and targeting system then utilizes a neural network encoder to generate a combined observed-unobserved embedding from the observed-unobserved vector that encodes the observed and unobserved analytics data for the user. Further, the unobserved behavior segmentation and targeting system uses a neural network predictor to generate a probability that the user will perform a target action.

As mentioned above, the unobserved behavior segmentation and targeting system accesses observed analytics data. For example, the unobserved behavior segmentation and targeting system accesses structured data representing observed behaviors or attributes of a user or users. Further, the unobserved behavior segmentation and targeting system generates unobserved analytics data. For example, in various embodiments, the unobserved behavior segmentation and targeting system determines various attributes and behaviors in the observed analytics data that are observed (e.g., performed) at a rate below a threshold observation rate (e.g., not performed or only performed minimally). In some embodiments, the unobserved behavior segmentation and targeting system samples one or more of these attributes and behaviors. For example, in one or more embodiments, the unobserved behavior segmentation and targeting system samples attributes and/or behaviors that have a threshold similarity to the attributes or behaviors from the observed analytics data.

As also mentioned above, in some embodiments the unobserved behavior segmentation and targeting system injects unobserved analytics data into observed analytics data. For example, the unobserved behavior segmentation and targeting system generates a sequence of observed attributes and/or behaviors from the observed analytics data. In some embodiments, the unobserved behavior segmentation and targeting system incorporates the unobserved analytics data by inserting unobserved analytics data into the sequence of observed attributes and/or behaviors. In further embodiments, the unobserved behavior segmentation and targeting system incorporates unobserved analytics data by replacing one or more attributes and/or behaviors in the sequence of observed analytics data with unobserved attributes and/or behaviors. In any event, the unobserved behavior segmentation and targeting system generates combined observed-unobserved vectors/sequences by injecting unobserved analytics data into observed analytics data.

As mentioned above, the unobserved behavior segmentation and targeting system utilizes a neural network encoder to encode combined observed-unobserved vectors and generate combined observed-unobserved embeddings. In some embodiments, the unobserved behavior segmentation and targeting system utilizes a single neural network encoder. In other embodiments, the unobserved behavior segmentation and targeting system utilizes a second neural network encoder that encodes the observed behaviors by generating observed embeddings from sequences of observed attributes or behaviors.

Additionally, in one or more implementations, the neural network encoder also utilizes different levels of attention to encode the observed and unobserved analytics data at both a page-level/click-action level and a session-level. For example, in one or more implementations, the neural network encoder comprises a hierarchical attention neural network that uses a first level of attention to encode actions (observed or unobserved) within each user session to action/page level vectors, representing actions within user sessions in a digital environment. The hierarchical attention neural network also utilizes a second level of attention to encode the action/page level vectors into a user-level vector, representing information combined from multiple user sessions.

The unobserved behavior segmentation and targeting system also optionally utilizes boosting when generating combined observed-unobserved embeddings or encodings. For example, the unobserved behavior segmentation and targeting system learns an observed weight and weights an observed embedding by the observed weight to create a weighted observed embedding. The unobserved behavior segmentation and targeting system also learns a combined unobserved-observed weight and weights a combined unobserved-observed embeddings by the combined observed-unobserved weight to create an observed-unobserved weighted embeddings. Further, the unobserved behavior segmentation and targeting system sums the weighted observed embedding and the observed-unobserved weighted embeddings. The unobserved behavior segmentation and targeting system uses the summed embedding for generating user segments.

As mentioned above, in one or more implementations, the unobserved behavior segmentation and targeting system generates a probability that a user will perform a target action. For example, the unobserved behavior segmentation and targeting system utilizes a predictor to generate a probability, from a combined observed-unobserved embedding, that a user will perform a target action.

In some embodiments, the unobserved behavior segmentation and targeting system generates user segments by clustering combined observed-unobserved vectors and utilizing a neural network selector to determine probability distributions over the user segments. The neural network predictor generates a probability that a user from the user segment will perform a target action (e.g., a user probability) and a probability that users from the user segment will perform a target action (e.g., a segment probability). Based on the user probability and the segment probability, the unobserved behavior segmentation and targeting system sends targeted content to the user or multiple users from the user segment.

As also mentioned above, in one or more embodiments, the unobserved behavior segmentation and targeting system utilizes mixed targeting. For example, the unobserved behavior segmentation and targeting system determines a first probability and a second probability of the probability distributions from the neural network selector meet a segment inclusion probability threshold. The unobserved behavior segmentation and targeting system includes the user in both a first user segment and a second user segment based on the first probability and a second probability meeting the segment inclusion probability threshold. Because the user belongs to both the first user segment and the second user segment, the unobserved behavior segmentation and targeting system sends the user first targeted content associated with the first user segment and second targeted content associated with the second user segment.

Although conventional systems segment users into groups and provide targeted content, such systems suffer from several drawbacks. For example, conventional systems are often inaccurate as they only account for behaviors that are observed firsthand (e.g., that were performed on their website or tracked with a digital cookie). However, it is a self-evident truism that users’ behaviors are influenced by behaviors that are outside of the view of conventional systems. By failing to account for unseen behaviors, conventional systems segment and predict action based on incomplete data resulting in less accurate segments and predictions.

Furthermore, although conventional systems segment users, conventional systems are inflexible and limit users to a single user segment. For instance, conventional systems theorize that effective segmentation requires mapping users to segments in a mutually exclusive way. However, in practice, this mutual exclusivity is unlikely to occur as users often exhibit behaviors of representative of two or more segments. Particularly where conventional systems are aimed at predicting user actions (e.g., purchase behaviors) of users or user segments, this inflexibility misses out on additional predictions (e.g., additional opportunities for marketing). Moreover, although conventional systems cluster users into user segments, such systems are inaccurate as they often use unsupervised clustering, which does not address predictive performance (e.g., key performance indicators, or KPI). By not comparing outcomes to predicted outcomes to actual outcomes, the accuracy of such systems is questionable.

The unobserved behavior segmentation and targeting system provides many advantages and benefits over conventional systems and methods. As mentioned above, the unobserved behavior segmentation and targeting system improves accuracy by incorporating unobserved behaviors and attributes when generating probabilities that users or user segments will perform target actions. In this way, the unobserved behavior segmentation and targeting system provides more accurate probabilities for users and user segments. Moreover, by generating more accurate probabilities, the unobserved behavior segmentation and targeting system provide targeted content that more accurately reflects content the user (or users from a user segment) wants or that will be effective.

Additionally, the unobserved behavior segmentation and targeting system is more flexible than conventional systems. In particular, the unobserved behavior segmentation and targeting system relaxes constraints utilized by conventional systems and allows for users to belong to more than one user segment. The unobserved behavior segmentation and targeting system performs mixed targeting by targeting a user multiple times due to the user being included in multiple different user segments.

As illustrated by the foregoing discussion, the present disclosure utilizes a variety of terms to describe features and advantages of the unobserved behavior segmentation and targeting system. Additional detail is now provided regarding the meaning of such terms. For example, as used herein, the term “analytics data” refers to digital data tracked or observed about users in relation to a digital environment (a website, native software application, etc.). For example, the term “observed analytics data” includes observed or tracked attributes, characteristics, interactions, traits, and behaviors that a user performed in a digital environment. The term “unobserved analytics data” refers to includes attributes, characteristics, interactions, traits, and behaviors corresponding to a user that a user may have had the opportunity to perform in a digital environment, but there is not a digital record indicating that the user performed a behavior.

Further, as used herein, the term “behaviors” refers to recorded interactions a user has in a digital environment or interactions that are available for a user to perform in a digital environment. In one or more embodiments, behaviors include, but are not limited to, data requests (e.g., URL requests, link clicks), time data (e.g., a time stamp for clicking a link, a time duration for a web browser accessing a webpage, a time stamp for closing an application), path tracking data (e.g., data representing webpages a user visits during a given session), geographic data (e.g., IP address, GPS data), transaction data (e.g., order history, email receipts), etc. As used herein, the term “attributes” refers to characteristic of user/visit. For example, an attribute comprises characteristics like demographic data (e.g., an indicated age, sex, or socioeconomic status of a user), geographic data (e.g., a physical address, GPS data), device characteristics (e.g., device brand, operating system, application version).

Along the same lines, as used herein, the term “observed attributes or behaviors” refers to attributes or behaviors that the unobserved behavior segmentation and targeting system has a digital record of the user performing. As used herein, the term “unobserved attributes or behaviors” refers to attributes or behaviors for which the unobserved behavior segmentation and targeting system does not have a record.

The term “machine learning,” as used herein, refers to the process of constructing and implementing algorithms that learn from and make predictions on data. In general, machine learning operate by building models from example inputs (e.g., user interaction data), such as training neural network layers and/or matrices, to make data-driven predictions or decisions.

As used herein, the term “neural network” refers to a machine learning model that is tunable (e.g., trained) based on inputs to approximate unknown functions. In particular, the term neural network includes a model of interconnected neurons that communicate and learn to approximate complex functions and generate outputs based on a plurality of inputs provided to the model. For instance, the term neural network includes an algorithm (or set of algorithms) that implements deep learning techniques that utilize a set of algorithms to model high-level abstractions in data using semi-supervisory data to tune the parameters of the neural network.

Further, in some embodiments, the unobserved behavior segmentation and targeting system utilizes a neural network encoder. As used herein, the term “neural network encoder” refers to a set of neural network layers that project data into a feature space. For example, a neural network encoder takes sequences of user behavior and outputs embeddings or projections of the user behavior into a feature space. As used herein, the term “neural network predictor” refers to one or more neural network layers that decode or generate a prediction from an embedding. For example, a neural network predictor takes feature embedding or encoding as input and outputs a prediction (e.g., a probability) that a user or segment represented by the embedding or encoding will perform a given action.

As mentioned above, the unobserved behavior segmentation and targeting system trains a neural network to learn user embeddings or encodings. As used herein, the terms “action-level embeddings,” “session-level embedding representations,” “observed embeddings,” or “combined observed-unobserved embeddings” refer to a vector of numbers/features that represent the behavior/attributes of a user or user segment encoded by a machine-learning model. For example, embeddings, in one or more implementations, comprise a vector of features generated utilizing a neural network encoder. In alternative implementations, embeddings comprise encodings generated utilizing a non-neural network machine learning model.

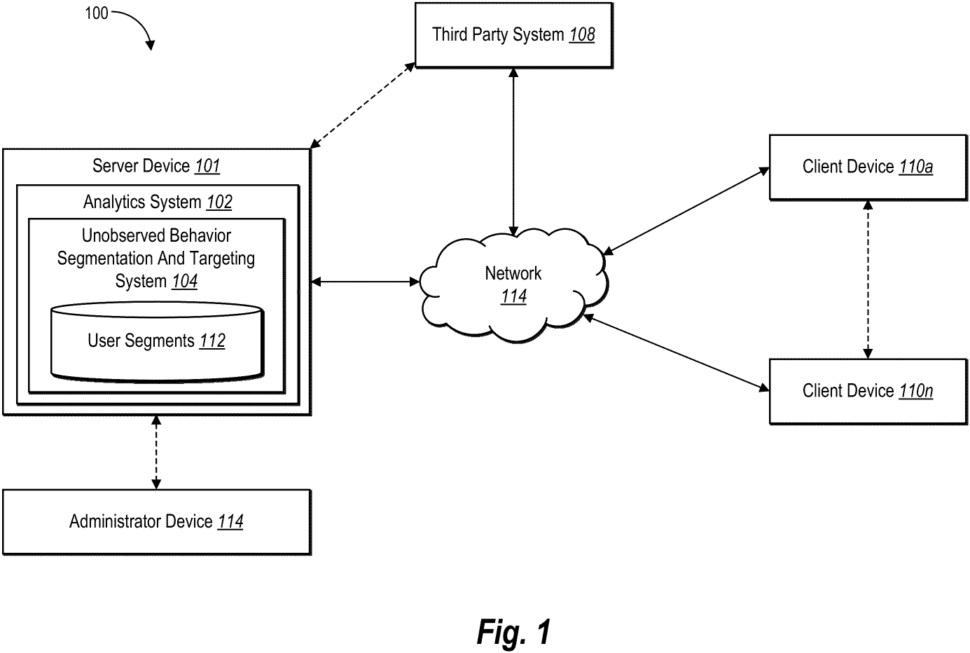

Referring now to the figures, FIG. 1 illustrates a diagram of an environment 100 in which the unobserved behavior segmentation and targeting system 104 operates in one or more implementations. As shown in FIG. 1, the environment 100 includes a server device 101, user client devices 110a-110n, and an administrator client device 114. In addition, the environment 100 includes a third-party server device 108 (e.g., one or more webservers). Each of the devices within the environment 100 communicate with each other via a network 112 (e.g., the Internet).

Although FIG. 1 illustrates a particular arrangement of components, various additional arrangements are possible. For example, the third-party server device 108 communicates directly with the server device 101. In another example, the third-party server device 108 is implemented as part of the server device 101 (shown as the upper dashed line). Likewise, the administrator client device 114 also is implemented as part of the server device 101 (shown as the lower dashed line) in one or more embodiments.

In one or more embodiments, users associated with the user client devices 110a-110n access content items provided by the analytics system 102 and/or the third-party server device 108 via one or more media channels (e.g., websites, native software applications, or electronic messages). As FIG. 1 illustrates, the environment 100 includes any number of user client devices 110a-110n.

As shown, the server device 101 includes an analytics system 102, which tracks the storage, selection, and distribution of content items as well as tracks user interactions with content via the user client devices 110a-110n. For example, the server device 101 is a single computing device or multiple connected computing devices. In one or more embodiments, the analytics system 102 facilitates serving content to users (directly or through the third-party server device 108) via one or more media channels to facilitate interactions between the users and the content.

In some embodiments, the analytics system 102 includes, or is part of, a content management system that executes various digital content campaigns across multiple digital media channels. Indeed, the analytics system 102 facilitates digital content campaigns, including audiovisual content campaigns, online content item campaigns, email campaigns, social media campaigns, mobile content item campaigns, as well as other campaigns. In various embodiments, the analytics system 102 manages advertising or promotional campaigns, which includes targeting and providing content items via various digital media channels in real-time to large numbers of users (e.g., to thousands of users per second and/or within milliseconds of the users accessing digital assets, such as websites).

In one or more embodiments, the analytics system 102 employs the unobserved behavior segmentation and targeting system 104 to facilitate the various digital content campaigns. In alternative embodiments, the analytics system 102 hosts (or communicates with) a separate content management system (e.g., a third-party system) that manages and facilitates various digital content campaigns.

As shown in FIG. 1, the analytics system 102 includes the unobserved behavior segmentation and targeting system 104. The unobserved behavior segmentation and targeting system 104 generates user segments 106 using unobserved analytics data as explained in greater detail below. As mentioned above, the environment 100 includes the user client devices 110a-110n. The analytics system 102 (or the third-party server device 108) provides content to, and receives indications of user interactions from, the user client devices 110a-110n. In various embodiments, the analytics system 102 communicates with the third-party server device 108 to provide content to the user client devices 110a-110n. For instance, the analytics system 102 instructs the third-party server device 108 to employ specific media channels when next providing content to target users based on the determined user segments or predictions of future actions by a user or user segments.

In one or more embodiments, the user client devices 110a-110n and/or server device 101 may include, but are not limited to, mobile devices (e.g., smartphones, tablets), laptops, desktops, or any other type of computing device, such as those described below in relation to FIG. 16. In addition, the third-party server device 108 (and/or the server device 101) includes or supports a web server, a file server, a social networking system, a program server, an application store, or a digital content provider. Similarly, the network 112 may include any of the networks described below in relation to FIG. 16.

The environment 100 also includes the administrator client device 114. An administrator user (e.g., an administrator, content manager, or publisher) utilizes the administrator client device 114 to manage a digital content campaign. For example, a content manager via the administrator client device 114 provides content and/or campaign parameters (e.g., targeting parameters, target media properties such as websites or other digital assets, budget, campaign duration, or bidding parameters). For example, with respect to a digital content campaign, the administrator employs the administrator client device 114 to access the unobserved behavior segmentation and targeting system 104 and view graphical user interfaces that include user segment visualizations across one or more digital content campaigns.

With respect to obtaining user interaction data, in one or more embodiments the analytics system 102 and/or the unobserved behavior segmentation and targeting system 104 monitors various user interactions, including data related to the communications between the user client devices 110a-110n and the third-party server device 108. For example, the analytics system 102 and/or the unobserved behavior segmentation and targeting system 104 monitors interaction data that includes, but is not limited to, data requests (e.g., URL requests, link clicks), time data (e.g., a timestamp for clicking a link, a time duration for a web browser accessing a webpage, a timestamp for closing an application, time duration of viewing or engaging with a content item), path tracking data (e.g., data representing webpages a user visits during a given session), demographic data (e.g., an indicated age, sex, or socioeconomic status of a user), geographic data (e.g., a physical address, IP address, GPS data), and transaction data (e.g., order history, email receipts).

The analytics system 102 and/or the unobserved behavior segmentation and targeting system 104 monitor user data in various ways. In one or more embodiments, the third-party server device 108 tracks the user data and then reports the tracked user data to the analytics system 102 and/or the unobserved behavior segmentation and targeting system 104. Alternatively, the analytics system 102 and/or the unobserved behavior segmentation and targeting system 104 receives tracked user data directly from the user client devices 110a-110n. In particular, the analytics system 102 and/or the unobserved behavior segmentation and targeting system 104 may receive user information via data stored on the client device (e.g., a browser cookie, cached memory), embedded computer code (e.g., tracking pixels), a user profile, or engage in any other type of tracking technique. Accordingly, the analytics system 102 and/or the unobserved behavior segmentation and targeting system 104 receives tracked user data from the third-party server device 108, the user client devices 110a-110n, and/or the network 112.

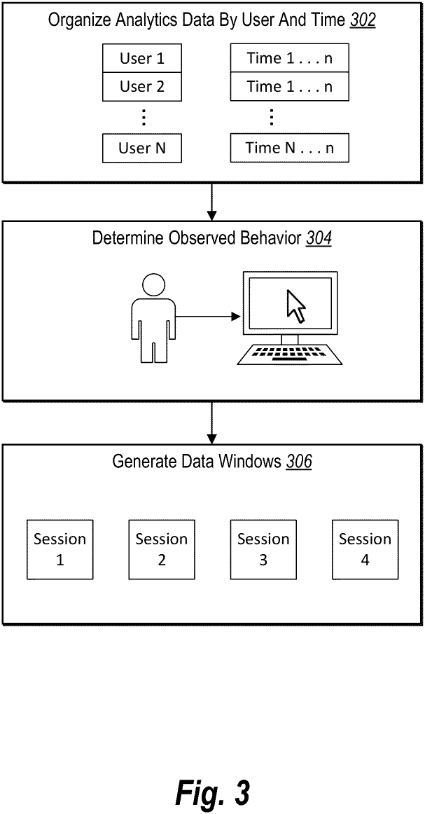

Upon receiving data (i.e., analytics data), in various embodiments, the unobserved behavior segmentation and targeting system 104 organizes the analytics data by user and time. For example, in some embodiments, the unobserved behavior segmentation and targeting system 104 organizes user data by user and by time for each session or visit. In another example, the unobserved behavior segmentation and targeting system 104 organizes data over a fixed time duration. Additional description of generating structured user data is provided below with respect to FIG. 3.

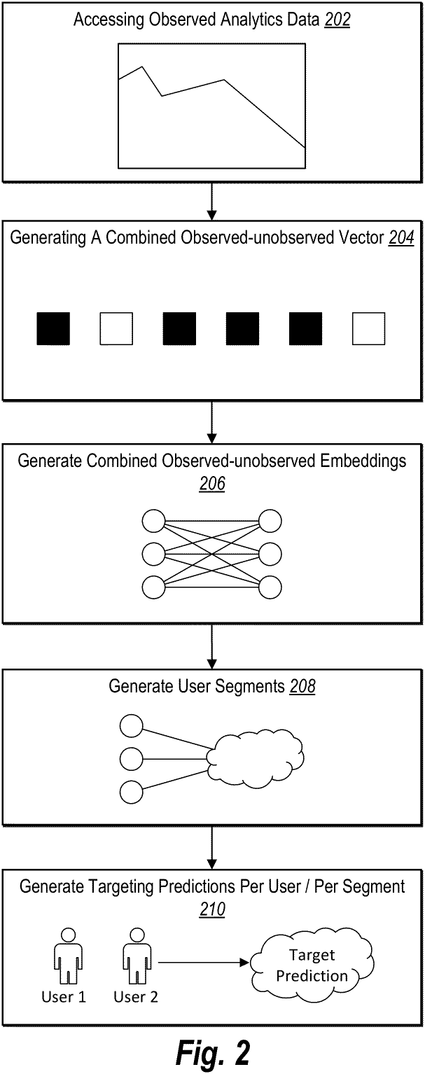

Turning now to FIG. 2, an overview is provided regarding how the unobserved behavior segmentation and targeting system 104 incorporates unobserved behavior when generating user segments and generating targeting predictions. More specifically, FIG. 2 illustrates an overview of a sequence of acts of accessing observed analytics data, incorporating unobserved behaviors, generating user segments, and generating targeted predictions for users and/or user segments in accordance with one or more embodiments.

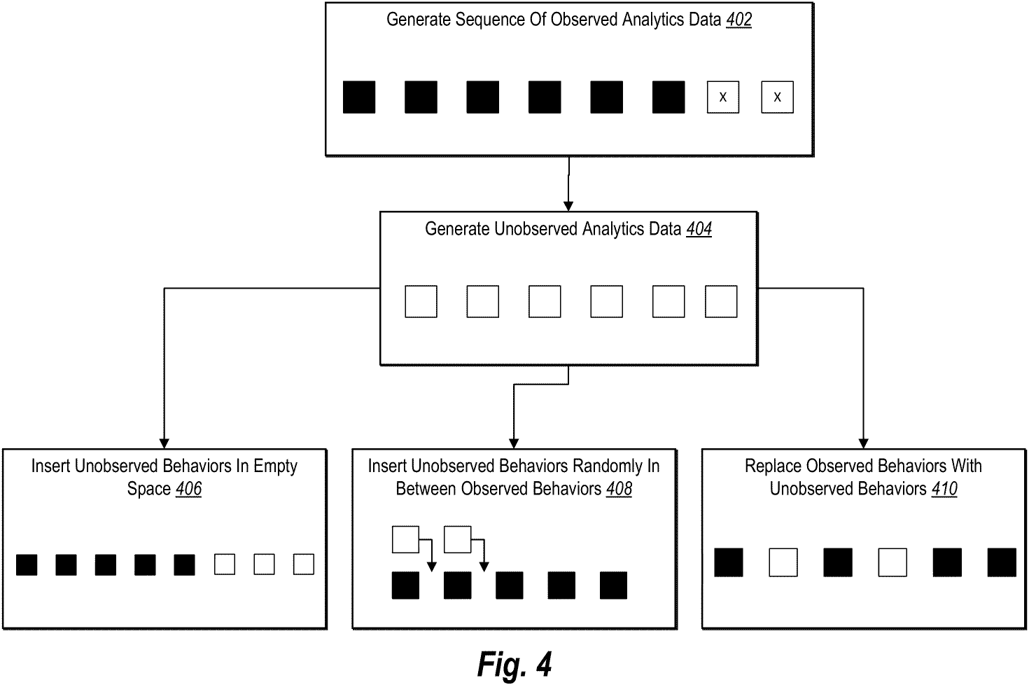

As illustrated in FIG. 2, the unobserved behavior segmentation and targeting system 104 performs act 202 of accessing observed analytics data. In particular, the unobserved behavior segmentation and targeting system 104 access observed data by accessing data representing behaviors performed by the user or attributes about the user. For example, in some embodiments, observed analytics data include various user interactions observed in a digital environment, such as websites visited, digital information stored while in digital environments (e.g., cookies), or information stored during authentication processes. In other embodiments, observed analytics data include traits or attributes of the user. Additional description regarding accessing and processing observed behaviors is provided with respect to FIG. 4 below.

As shown in FIG. 2, the unobserved behavior segmentation and targeting system 104 performs act 204 of generating a combined observed-unobserved vector. In particular, the unobserved behavior segmentation and targeting system 104 generates a combined observed-unobserved vector by injecting unobserved observation data into sequences of observed behaviors or attributes. For example, the unobserved behavior segmentation and targeting system 104 inserts unobserved analytics data into empty spaces in a sequence of observed attributes or behaviors, inserts unobserved analytics data randomly in between observed attributes or behaviors in the sequence of observed attributes or behaviors, or replaces one or more attributes or behaviors in the sequence of observed attributes or behaviors with the unobserved analytics data. Additional description regarding generating unobserved analytics data and combining the observed analytics data and the unobserved analytics data into a combined observed-unobserved vector is provided with respect to FIG. 4 below.

As further illustrated in FIG. 2, in some embodiments, the unobserved behavior segmentation and targeting system 104 performs act 206 of generating combined observed-unobserved embeddings. For example, the unobserved behavior segmentation and targeting system 104 utilizes a neural network encoder to generate embeddings from various behavior vectors. In some embodiments, the unobserved behavior segmentation and targeting system 104 utilizes a first neural network encoder that generates observed embeddings from sequences of observed attributes or behaviors and a second neural network encoder that generates combined observed-unobserved embeddings from observed-unobserved vectors.

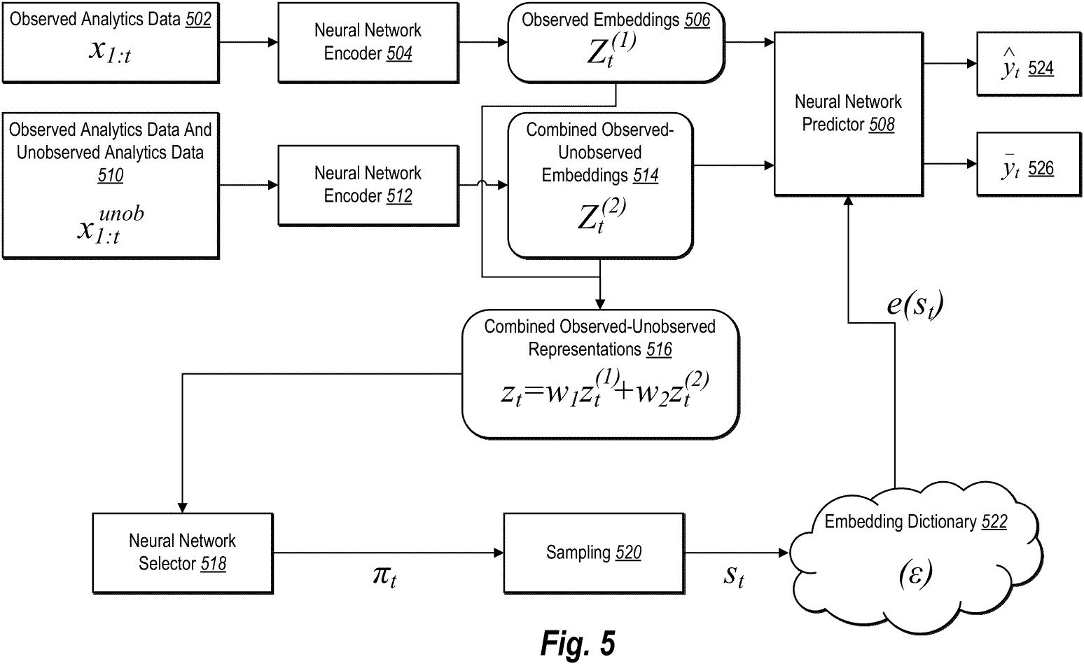

Moreover, as illustrated in FIG. 2, in some embodiments the unobserved behavior segmentation and targeting system 104 performs act 208 of generating user segments. For example, in some embodiments, the unobserved behavior segmentation and targeting system 104 generates user segments by clustering combined observed-unobserved vectors, such as by using K-means clustering or another cluster algorithm. Additional description regarding generating unobserved analytics data and generating user segments is provided with respect to FIG. 5 below.

As also illustrated in FIG. 2, in some embodiments the unobserved behavior segmentation and targeting system 104 generates targeted predictions for users or user segments in act 210. For example, the unobserved behavior segmentation and targeting system 104 utilizes a neural network predictor to generate a user probability that a user will perform a target action based on an observed vector or an observed-unobserved vector. In other embodiments, the unobserved behavior segmentation and targeting system 104 utilizes a neural network predictor to generate a segment probability that users from a user segment will perform a target action.

Moreover, as explained above, in some embodiments the unobserved behavior segmentation and targeting system 104 generates target predictions for users based on including a user or users in more than one user segment. For example, the unobserved behavior segmentation and targeting system 104 determines that a first probability and a second probability from a probability distribution meets a segment inclusion probability threshold. The unobserved behavior segmentation and targeting system 104 then includes a user in both a first user segment associated with the first probability and a second user segment associated with the second probability. Further, the unobserved behavior segmentation and targeting system 104 generates, utilizing a neural network predictor, a first segment probability for the first segment that indicates whether users from the first user segment will perform a target action and a second segment probability that indicates whether users from the second user segment will perform a target action. Upon determining that the first segment probability and the second segment probability satisfy a targeting probability threshold, the unobserved behavior segmentation and targeting system 104 sends first targeted content to users in the first user segment and sends second targeted content to users in the second user segment, both which contain the user.

Turning now to FIG. 3, additional detail is provided regarding accessing and processing observed analytics data. More specifically, FIG. 3 illustrates the unobserved behavior segmentation and targeting system 104 accessing and processing observed data in accordance with one or more embodiments.

As illustrated in FIG. 3, the unobserved behavior segmentation and targeting system 104 performs act 302 of retrieving and organizing data by user and time. For example, the unobserved behavior segmentation and targeting system 104 receives data representing observed behaviors (e.g., actions taken by a user in a digital environment) from client devices 110a-110n. In one or more implementations, the unobserved behavior segmentation and targeting system 104 organizes the data by user, per period of time, with rows as time-stamped behaviors. For example, the unobserved behavior segmentation and targeting system 104 organizes observed behaviors by a user during a given period of time. In some embodiments, the unobserved behavior segmentation and targeting system 104 denotes a period of time as a user session, such as the length of time the user completes the activities. In other embodiments, the unobserved behavior segmentation and targeting system 104 denotes a period of time of a fixed duration, such as a week. In further embodiments, if a timestamp is missing, the unobserved behavior segmentation and targeting system 104 puts the behaviors in sequence.

As further illustrated in FIG. 3, the unobserved behavior segmentation and targeting system 104 performs act 304 by processing the observed behavior. For example, the unobserved behavior segmentation and targeting system 104 processes the observed behavior by identifying actions performed by users in relation to a given digital environment. As noted above, observed behavior can comprise various actions, including but not limited to, webpage visits, links clicked, advertisements seen, emails opened, clicks on emails, selecting an unsubscribe option, application downloads, items added to a digital shopping cart, purchases, subscriptions, etc. As an illustrative example for use in explaining observed behaviors, the example of visiting webpages is described hereinbelow. One will appreciate that this is provided for illustrative purposes and other implementations include other types of observable actions. As an example, the unobserved behavior segmentation and targeting system 104 generates a list of webpages and creates (e.g., with doc2vec) embeddings of the various webpage names. The unobserved behavior segmentation and targeting system 104 then identifies which webpages a given user visited and then marks the visited webpage names as the observed behavior for the user. In other implementations, the unobserved behavior segmentation and targeting system 104 generates one-hot encodings for events of observed behaviors.

In other embodiments, the unobserved behavior segmentation and targeting system 104 determines observed behaviors by determining a subset of a digital environment that users visit covers a high percentile of overall user visits. For example, in some use cases, a small subset of webpages of a website make up a large percentage of observed behaviors. For example, a website may contain 17,500 page-URLs. In this example, a large percentage of visits to the website (e.g., 90-percent) are to a relatively small subset of the total 17,500 page-URLs (e.g., approximately 70 page-urls). In such an implementation, the unobserved behavior segmentation and targeting system 104 marks visits to the 70 pages as the observed behaviors for that dataset. The unobserved behavior segmentation and targeting system 104 generates unobserved behavior as visits to the other 17,430 page-URLs.

As also illustrated in FIG. 3, the unobserved behavior segmentation and targeting system 104 performs act 306 by organizing the observed behaviors by generating data windows. Specifically, the unobserved behavior segmentation and targeting system 104 organizes the observed behaviors by creating windows, where each window comprises several successive sessions. In some embodiments, the unobserved behavior segmentation and targeting system 104 creates windows by grouping a predetermined number of successive sessions. In one or more implementations, the unobserved behavior segmentation and targeting system 104 allows a user to select a window size. Still further, in one or more implementations, the unobserved behavior segmentation and targeting system 104 utilizes rolling windows.

Turning now to FIG. 4, additional detail is provided regarding generating and injecting unobserved behavior into sequences of observed attributes or behaviors. More specifically, FIG. 4 illustrates the unobserved behavior segmentation and targeting system 104 generating unobserved analytics data and injecting unobserved analytics data into the sequences of observed behaviors or attributes.

As shown, the unobserved behavior segmentation and targeting system 104 performs act 402 of generating sequences of observed attributes or behaviors. For example, as explained in FIG. 3, the unobserved behavior segmentation and targeting system 104 organizes the observed analytics data by user and time. In one or more implementations, the generates sequence of observed analytics data by generating vectors observed analytics data having a predetermined dimension. In such implementations, some sequences of observed analytics data may not have enough observed attributes or behaviors to have entries to meet the predetermined dimension. In such instances the unobserved behavior segmentation and targeting system 104 pads the sequence of observed analytics data.

The unobserved behavior segmentation and targeting system 104 performs act 404 of generating unobserved analytics data. For example, the unobserved behavior segmentation and targeting system 104 generates unobserved analytics data by performing constrained sampling of attributes or behaviors that have an observation rate in the observed analytics data below a threshold observation rate (e.g., that users did not perform or very rarely performed). In some examples, the unobserved behavior segmentation and targeting system 104 randomly draws from the attributes or behaviors that have an observation rate below a threshold observation rate to generate an unobserved behavior vector.

Then, the unobserved behavior segmentation and targeting system 104 determines if the vector has a threshold similarity to the observed behavior to avoid generating unobserved behavior too similar to the observed behavior. In some embodiments, the unobserved behavior segmentation and targeting system 104 determines the threshold similarity utilizing a cosine similarity between observed behaviors and the unobserved behaviors. In other embodiments, the unobserved behavior segmentation and targeting system 104 generates unobserved data by randomly drawing from behaviors not commonly performed in a given digital space.

Upon generating the unobserved analytics data, the unobserved behavior segmentation and targeting system 104 injects the unobserved analytics data into the sequences of observed analytics data. For example, in act 406 the unobserved behavior segmentation and targeting system 104 injects unobserved behaviors into empty spaces (e.g., the padding) of a sequence of observed analytics data. In another embodiments, in act 408, the unobserved behavior segmentation and targeting system 104 injects unobserved behaviors into randomly in between observed behaviors of a sequence of observed analytics data. In still further embodiments, the unobserved behavior segmentation and targeting system 104 injects by replacing observed behaviors with unobserved behaviors a sequence of observed analytics data in act 410.

As a non-limiting example, in one or more implementations, analytics data comprises time stamped behavioral data in the form of webpages (e.g., page-urls) browsed by each user. Specifically, in this example observed behaviors are depicted by the page-urls navigated in sequence by a user. The unobserved behavior segmentation and targeting system 104 divides the set of all page-urls into sets of observed and unobserved behaviors as explained below. The analytics data shows in this example that out of the set of all page-urls, very few are browsed by users. The analytics data also shows that there is variance among users in which page-urls are browsed.

The unobserved behavior segmentation and targeting system 104 identifies unobserved behaviors, in one or more implementations, for each user, by defining user-specific (e.g., unobserved behaviors, as page-urls that the user did not browse among the set of all page-URLs (or browsed at a low frequency). In other implementations to generate consistent unobserved behaviors common to all users, the unobserved behavior segmentation and targeting system 104 defines a set of page-urls that cover a high percentile of the whole dataset, as the set of observed behaviors. The unobserved behavior segmentation and targeting system 104 determines the users’ observed page-urls from this set. When determining observed behaviors, the unobserved behavior segmentation and targeting system 104 disregards any page-URL not in this set. The unobserved behavior segmentation and targeting system 104 uses the complement set of page-urls for the unobserved behaviors.

For example,

$$O$$

represents the set of all page-urls browsed, as shown in the analytics data. Typically, across all users in the analytics data, a small subset of page-urls, denoted

$$B ,$$

covers a large percentile of the browsed page-urls. The unobserved behavior segmentation and targeting system 104 defines observed behaviors as elements of

$$B ,$$

and unobserved behaviors as elements of

$$D / B .$$

The unobserved behavior segmentation and targeting system 104 utilizes a doc2vec to generate vectors representing the observed behaviors and the unobserved behaviors. In one or more implementations, the unobserved behavior segmentation and targeting system 104 trains the doc2vec model on all page-URLs in

$$O$$

to learn a 20-dimensional document vector for each page-URL.

$$F$$

represents the set of 20-dim vectors corresponding to

$$O ,$$

and

$$U$$

represents those 20-dim vectors that correspond to

$$O / B .$$

The unobserved behavior segmentation and targeting system 104 draws each vector for the unobserved behavior randomly from U and inserts the unobserved behavior into a session of observed behavior for each user. In one or more implementations, prior to inserting the unobserved data into a vector of observed data, the unobserved behavior segmentation and targeting system 104 ensures that the unobserved data satisfies one or more conditions. If an iteration of unobserved data does not satisfy the one or more conditions, the unobserved behavior segmentation and targeting system 104 disregards the iteration and randomly drawings another vector from

$$A$$

and checks it against the one or more conditions. The unobserved behavior segmentation and targeting system 104 repeats this process until generating adequate unobserved behavior for a given user.

For example, the unobserved behavior segmentation and targeting system 104 ensures that the unobserved behavior being injected into a vector of observed behavior is not too similar to the observed behavior. For example, the average cosine similarity with the vectors for observed behaviors lie in the range (0, r), where the average is the mean of cosine similarity between the unobserved behavior vector and each observed behavior vector, over all observed behavior vectors. In one or more implementations, r is the maximum degree of average similarity allowed, a hyperparameter. By ensuring that ingested unobserved behaviors are not too similar to observed behaviors, the unobserved segmentation and targeting system 104 avoids exacerbating the effect of unobserved behaviors on the outcome. In one or more implementations, the unobserved behavior segmentation and targeting system 104 uses r=0.4 to draw unobserved behaviors with average cosine similarity in the range (0,0.4). In alternative implementations, the unobserved behavior segmentation and targeting system 104 uses a range of (0,0.2) or r.

In another implementation, the unobserved behavior segmentation and targeting system 104 follows a Markov transition when injecting unobserved behavior where p1 is the probability that the next behavior is an observed behavior given that the current behavior is an observed behavior, and p2 is the probability that the next behavior is an unobserved behavior given that the current behavior is an unobserved behavior. In this manner, 1-p1 is the probability that the next behavior is an unobserved behavior given that the current behavior is an observed behavior, and 1-p2 is the probability that the next behavior is an observed behavior given that the current behavior is an unobserved behavior. The unobserved behavior segmentation and targeting system 104 varies pl and p2, as hyperparameters in one or more implementations.

Turning now to FIG. 5, additional detail is provided regarding the methods and systems for incorporating unobserved behavior and generating user segments. In particular, FIG. 5 illustrates various components of the unobserved behavior segmentation and targeting system 104. As illustrated in FIG. 5, the unobserved behavior segmentation and targeting system 104 a deep learning based neural network architecture. In particular, the unobserved behavior segmentation and targeting system 104 includes one or more neural network encoders (e.g., encoders 504 and 512), a neural network predictor 508, and a neural network selector 518. Each of these components of the unobserved behavior segmentation and targeting system 104 are described in greater detail below.

As described above, the unobserved behavior segmentation and targeting system 104 generates observed analytics data 502 in the form of sequences of observed attributes or behaviors (also referred herein as observed vectors) in sessions up to session t, such as x₁:ₜ= {x₁, x₂, . . . xₜ}. Similarly, the unobserved behavior segmentation and targeting system 104 combines observed and unobserved analytics data 510 into combined observed-unobserved vectors until session t as

$${x}_{1 : t}^{u n o b}$$

as described above in relation to FIG. 4

The unobserved behavior segmentation and targeting system 104 generates observed embeddings from the observed vectors utilizing the neural network encoder 504. In particular, at each timestamp t, the unobserved behavior segmentation and targeting system 104 generates observed embeddings 506

$$\left({z}_{t}^{\left(1\right)}\right)$$

utilizing the neural network encoder 504. In other words, the neural network encoder 504 generates observed embeddings 506 that are latent encodings that are used for clustering or predictions, as explained further below.

The unobserved behavior segmentation and targeting system 104 generates combined observed-unobserved embeddings from the combined observed-unobserved vectors utilizing the neural network encoder 512. In particular, at each timestamp t, the unobserved behavior segmentation and targeting system 104 generates combined observed-unobserved embeddings 514

$$\left({z}_{t}^{\left(2\right)}\right)$$

utilizing the neural network encoder 512. In other words, the neural network encoder 504 generates combined observed-unobserved embeddings 514 that are latent encodings that are used for clustering or predictions, as explained further below.

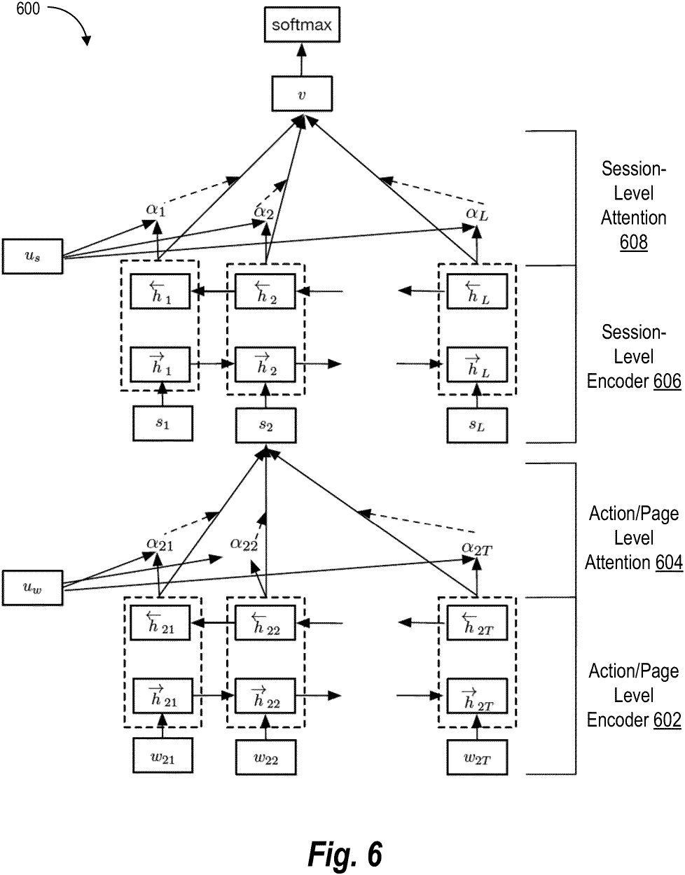

In one or more implementations, the neural network encoders 504 and 512 have a similar architecture. For example, in one or more implementations, the neural network encoders 504 and 512 comprise a recurrent neural network, LSTM cells, an autoencoder, or a hierarchical attention neural network as described in greater detail below in connection with FIG. 6

As shown in FIG. 5, the unobserved behavior segmentation and targeting system 104 also includes a neural network predictor 508. For example, the neural network predictor 508 is a fully-connected network that takes embeddings as input and predicts an outcome. In some embodiments, the neural network predictor 508 is a Multi-Layered Perceptron (MLP) with input Zₜ (of dimension 50), one hidden layer with 50 perceptrons and an output layer of size 1. In one or more implementations, the unobserved behavior segmentation and targeting system 104 uses a dropout rate of 0.3 after the hidden layer and the hidden layers have ReLU activation and the output layer has sigmoid activation. Specifically, the neural network predictor 508 takes embeddings as input and outputs a probability ŷₜ (524) that a user will perform a target action or a probability y̅ₜ (526) that a segment of users will perform a target action.

As further illustrated in FIG. 5, the unobserved behavior segmentation and targeting system 104 generates combined observed-unobserved representations 516. In particular, the unobserved behavior segmentation and targeting system 104 generates the combined observed-unobserved representations 516 by combining the observed embeddings 506 (zₜ) and the combined observed-unobserved embeddings 514

$$\left({z}_{t}^{\left(2\right)}\right) .$$

In one or more implementations, the unobserved behavior segmentation and targeting system 104 generates the combined observed-unobserved representations 516 utilizing boosting weights w₁ and w₂ as explained in greater detail below.

The unobserved behavior segmentation and targeting system 104 determines a number of user segments from user input or as a hyperparameter. Alternatively, the unobserved behavior segmentation and targeting system 104 learns the number of user segments through optimization. For example, the unobserved behavior segmentation and targeting system 104 selections different values of K (for use with a K-means cluster algorithm) and chooses a value of K with the highest performance value. Based on the number of desired user segments, the unobserved behavior segmentation and targeting system 104 sets a number of clusters (πₜ). The unobserved behavior segmentation and targeting system 104 then generates a probability distribution over the clusters (πₜ) from the combined observed-unobserved representations 516 utilizing the neural network selector 518. Specifically, the neural network selector 518, in one or more implementations, comprises a fully-connected network. For example, the neural network selector 518, in one or more implementations, comprises an MLP with input zₜ, followed by hidden layer 50, which uses ReLU activation and a dropout 0.3. In one or more implementations, the output layer is of size k (= 5), with softmax activation.

As also shown in FIG. 5, the unobserved behavior segmentation and targeting system 104 samples 520 the clusters (πₜ) to determine a sampled cluster assignment Sₜ~Cat(πₜ). In particular, the unobserved behavior segmentation and targeting system 104 samples the clusters (πₜ) based on the probability distribution generated by the neural network selector 518.

Further, as shown, the unobserved behavior segmentation and targeting system 104 maps the sampled cluster assignment Sₜ to centroid embedding e(Sₜ). Specifically, the unobserved behavior segmentation and targeting system 104 utilizes the embedding dictionary 522 to map the clusters to their respective centroid embedding e(Sₜ). In one or more implementations, the embedding dictionary 522 comprises a dictionary mapping to centroid embedding e(Sₜ) in the latent space. Furthermore, the unobserved behavior segmentation and targeting system 104 generates, from the centroid embeddings e(Sₜ) utilizing the neural network predictor 508, target action probabilities a corresponding user segment will perform a target action, as described above.

The neural network encoders 504, 512, neural network predictor 508, and neural network selector 518 each include parameters or weights that the unobserved behavior segmentation and targeting system 104 learns via a training process. For example, the unobserved behavior segmentation and targeting system 104 learns the parameters for the neural network encoder 504 and the neural network predictor 508 utilizing a prediction loss. Specifically, the unobserved behavior segmentation and targeting system 104 trains the neural network encoder 504 and neural network predictor 508 on training sequences of observed attributes or behaviors (xₜ) and predicted outputs (y) based on the following loss:

$${L}_{1}^{\left(1\right)} \left(θ , ∅\right) = {E}_{x , y \sim P X Y} \left[- {\sum }_{t ∈ T} {l}_{1} \left({y}_{t} , {\overline{y}}_{t}\right)\right]$$

where ŷₜ is the probability for a target action generated by neural network predictor 508. For example, the target action is denoted by

$${\hat{y}}_{t} = {g}_{ϕ} \left({f}_{θ}^{\left(1\right)} \left({x}_{t}\right)\right) ,$$

wherein g_{Φ} represents neural network predictor 508,

$${f}_{θ}^{\left(1\right)}$$

represents neural network encoder 504 and l₁(yₜ, y̅ₜ) is given by

$$- \sum {}_{c ∈ \left\{0 , 1\right\}} {y}_{t}^{c} log \left({\hat{y}}_{t}^{c}\right) .$$

The unobserved behavior segmentation and targeting system 104 utilizes weights learned by boosting to generate combined observed-unobserved representations and explain any residuals using the unobserved behaviors. Specifically, the unobserved behavior segmentation and targeting system 104 generates predictions and user segments based on observed behaviors. The unobserved behavior segmentation and targeting system 104 then uses unobserved behaviors on the analytics data with a different distribution, which weighs the data points which were miss-predicted in the first part differently than those which were correctly predicted in the first part. The distribution, the weights and losses are explained below.

In some embodiments, the unobserved behavior segmentation and targeting system 104 learns a weight w₁ for observed sequences and a weight w₂ for combined observed-unobserved sequences. The unobserved behavior segmentation and targeting system 104 combines observed embeddings zₜ and combined observed-unobserved embeddings

$${z}_{t}^{\left(2\right)}$$

utilizing the weight w₁ for observed sequences and the weight w₂ for combined observed-unobserved sequences to generate combined observed-unobserved representations 516 zₜ.

For example, in some embodiments the unobserved behavior segmentation and targeting system 104 learns a weight w₁ for observed sequences during training of neural network encoder 504 and neural network predictor 508. Specifically, the unobserved behavior segmentation and targeting system 104 utilizes neural network encoder 504 and neural network predictor 508 to generate a first set of predicted outputs. The unobserved behavior segmentation and targeting system 104 then determines a mean loss based on a first set of predicted outputs and generates the weight w₁ for observed sequences based on the observed mean empirical loss. For example, if the mean empirical loss for neural network encoder 504 is ∈₁, the weight for observed sequences is by

$${w}_{1} = max \left\{0 , 0.5 log \left(\frac{1}{{ε}_{1}} - 1\right)\right\} .$$

The unobserved behavior segmentation and targeting system 104 then updates the distributions by the following:

$${D}_{t}^{\left(i\right)} = \frac{exp \left(- 4 {w}_{1} \left({y}_{t}^{\left(i\right)} - 1\right) \left(1 \left\{{\hat{y}}_{t}^{\left(i\right)} > 0.5\right\} - 1\right)\right)}{{\sum }_{j , s} exp \left(- 4 {w}_{1} \left({\text{y}}_{s}^{\left(i\right)} - 1\right) \left(1 \left\{{\hat{\text{y}}}_{\text{s}}^{\left(j\right)} > 0.5\right\} - 1\right)\right)}$$

where superscript (i) denotes the i^{th} data point (e.g., the user).

Further, the unobserved behavior segmentation and targeting system 104 learns a weight w₂ for combined observed-unobserved sequences while training neural network encoder 512 and neural network predictor 508. Specifically, the unobserved behavior segmentation and targeting system 104 generates the weight w₂ for combined observed-unobserved sequences by generate a second set of predicted outputs from training combined observed-unobserved vectors. The unobserved behavior segmentation and targeting system 104 then determines a mean loss based on the second set of precited outputs. For example, the unobserved behavior segmentation and targeting system 104 generating a combined observed-unobserved loss based on the combined mean loss, as follows:

$${L}_{1}^{\left(2\right)} \left(∅ , ϕ\right) = {E}_{X , \text{y} \sim {\text{D}}_{X Y}} \left[- {\sum }_{t ∈ T} {\text{D}}_{t} {l}_{1} \left({y}_{t} , {\hat{y}}_{t}\right)\right]$$

where

$${\hat{y}}_{t} = {g}_{ϕ} \left({f}_{θ}^{\left(2\right)} \left({u}_{t}\right)\right) ,$$

and wherein g_{Φ} represents neural network predictor 508 and

$${f}_{θ}^{\left(2\right)}$$

represents neural network encoder 512. If ∈₂ denotes the combined observed-unobserved loss for neural network encoder 512, then the weight for combined observed-unobserved sequences is depicted by

$${w}_{2} = max \left\{0 , 0.5 log \left(\frac{1}{{ε}_{2}} - 1\right)\right\} .$$

Once the weight for observed sequences and the weight for combined observed-unobserved sequences are determined, the unobserved behavior segmentation and targeting system 104 utilizes them to combine the observed embeddings and the combined observed-unobserved embeddings to generate combined observed-unobserved representations. Specifically, the unobserved behavior segmentation and targeting system 104 weights the observed embeddings by the weight w₁ for observed sequences and weights the combined observed-unobserved embeddings by the weight w₂ for combined observed-unobserved sequences and sums them together. The combined observed-unobserved representations is represented by

$${z}_{t} = {w}_{1} ⋅ {z}_{t}^{1} + {w}_{2} ⋅ {z}_{t}^{2} ,$$

where

$${z}_{t}^{1} = {f}_{θ}^{\left(1\right)} \left({x}_{t}\right)$$

and

$${z}_{t}^{2} = {f}_{θ}^{\left(2\right)} \left({u}_{t}\right) .$$

To initialize the cluster embeddings, the unobserved behavior segmentation and targeting system 104 performs K-means clustering over the generated combined observed-unobserved representations zₜ for all users at timestep t. The unobserved behavior segmentation and targeting system 104, in one or more implementations, pretrains the neural network selector 518 on all generated combined observed-unobserved representations zₜ considering the target labels as the initialized cluster assignments.

The unobserved behavior segmentation and targeting system 104 trains neural network encoder 504, neural network encoder 512, and selector 518 to ensure that the user segments are well separated, and a user belongs to a cluster with a high probability. Specifically, in some embodiments, neural network encoder 504, neural network encoder 512 and neural network selector 518 are optimized based on an entropy, that is by summing a separation loss that accounts for predicting the outcome of the combined observed-unobserved representations zₜ and a user segment loss that ensures that the combined observed-unobserved representation zₜ with the highest probability is selected for a given sub-sequence of user behavior. For example, the unobserved behavior segmentation and targeting system 104 determines the separation loss as follows:

$${L}_{1} \left(θ , ϕ , ψ , ε\right) = {E}_{X , \text{y} \sim {p}_{X Y}} \left[- {\sum }_{t ∈ T} {E}_{{s}_{t} \sim C a t \left({π}_{t}\right)} \left[{l}_{1} \left({y}_{t} , {\overline{y}}_{t}\right)\right]\right]$$

The user segment loss can be found by the following:

$${L}_{2} \left(θ , ψ\right) = {E}_{X \sim {p}_{X}} \left[- {\sum }_{t ∈ T} {\sum }_{k ∈ K} {π}_{t} \left(k\right) log {π}_{t} \text{} \left(k\right)\right]$$

The unobserved behavior segmentation and targeting system 104 also trains neural network encoder 504, neural network encoder 512 and neural network selector 518 on a gradient loss. In some embodiments, the unobserved behavior segmentation and targeting system 104 determines the gradient loss as follows:

$${L}_{A} \left(θ , ϕ , ψ\right) = {L}_{1} \left(θ , ϕ , ψ\right) + α {L}_{2} \left(θ , ψ\right)$$

where α ≥ 0 is a hyperparameter.

The unobserved behavior segmentation and targeting system 104 further trains neural network predictor 508 to ensure that the centroids are represented by well-separated embeddings in the latent space. For example, the unobserved behavior segmentation and targeting system 104 determines a mean centroid loss for the centroid combined observed-unobserved representations and determines that the mean centroid loss is above a mean centroid loss threshold. The unobserved behavior segmentation and targeting system 104 determines the mean centroid loss as follows:

$${L}_{3} \left(E\right) = - {\sum }_{k \neq {k}^{′}} {l}_{1} \left({g}_{ϕ} e \left(k\right) , {g}_{ϕ} e \left({k}^{′}\right)\right)$$

Turning now to FIG. 6, additional detail is provided regarding encoding analytics data. More specifically, FIG. 6 illustrates a Hierarchical Attention Network (HAN) utilized by the unobserved behavior segmentation and targeting system 104 to encode session-level analytics data into action/page level vectors, which are further encoded into user-level vectors.

As shown in FIG. 6, in some embodiments the unobserved behavior segmentation and targeting system includes HAN 600 that encodes user activities in a session to action/page-level vectors and then into session-level vectors. For example, HAN 600 projects data into a vector representation on which a classifier is built to perform classification by building a user-level vector progressively from session activities by using a hierarchical structure. HAN 600 projects raw analytics data into vector representations on which a classifier is built to perform behavior classification using a hierarchical structure.

As illustrated, HAN 600 includes action/page level encoder 602 that embeds session-level analytics data to action/page level vectors. For example, if wᵢₜ with t ∈ [1,T] represents the session-level analytics data in the ith session-level analytics data, given session-level analytics data with session-level analytics data wᵢₜ, t ∈ [0,T], action/page level encoder 602 embeds the session-level analytics data to vectors through an embedding matrix Wₑ, xᵢⱼ = Wₑwᵢⱼ. In some embodiments, action/page level encoder 602 utilizes a bidirectional gated recurrent unit (GRU) based sequence encoder to get annotations of session-level analytics data by summarizing information from both directions of action/page level analytics data. The bidirectional GRU contains the forward GRU f̅, which reads the action/page level analytics data from wᵢ₁ to w_{iT} and a backward GRU f̅ which reads from W_{iT} to wᵢ₁ as such:

$${x}_{i t} = {W}_{e} {w}_{i t} , t ∈ \left[1 , T\right] ,$$

$${\vec{h}}_{i t} = \vec{\text{GRU}} \left({x}_{i t}\right) , t ∈ \left[1 , T\right] ,$$

$${\overleftarrow{h}}_{i t} = \overleftarrow{\text{GRU}} \left({x}_{i t}\right) , t ∈ \left[1 , T\right] ,$$

The action/page level encoder 602 obtains annotation for given action/page level analytics data wᵢₜ by concatenating the forward hidden state h̅ᵢₜ and backward hidden state h̅ᵢₜ (i.e., hᵢₜ = [h̅ᵢₜ, h̅_{it]}), which summarizes the information of the whole action/page level analytics data centered around Wᵢₜ.

As further illustrated, HAN 600 includes action/page level attention 604 that extracts action/page level analytics data that influences the behavior of a user and aggregates the representation of the informative action/page level analytics data to form an action/page level vector (Sᵢ) as given:

$${u}_{i t} = tanh \left({W}_{w} {h}_{i t} + {b}_{w}\right)$$

$${α}_{i t} = \frac{exp \left({u}_{i t}^{} {u}_{w}\right)}{{\sum }_{t} exp \left({u}_{i t}^{} {u}_{w}\right)}$$

$${s}_{i} = {\sum }_{t} {α}_{i t} {h}_{i t} .$$

The unobserved behavior segmentation and targeting system 104 feeds action/page level analytics data is first through a one-layer MLP to get uᵢₜ as a hidden representation of hᵢₜ. Then, the unobserved behavior segmentation and targeting system 104 measures the importance of the action/page level analytics data as the similarity of uᵢₜ with an action/page level context vector u_{w} to get an action/page level normalized importance weight αᵢₜ, through a SoftMax function. Further, the unobserved behavior segmentation and targeting system 104 determines an action/page level vector Sᵢ as a weighted sum of the action/page level annotations based on the weights. In this way, an action/page level context vector u_{w} is as a high-level representation of a fixed query “what is the important action/page behavior.” The unobserved behavior segmentation and targeting system 104 randomly initiates the action/page level context vector u_{w} and jointly learns the action/page level context vector u_{w} during the training process.

As further shown in FIG. 6, HAN 600 includes session-level encoder 606 that embeds action/page level vectors to session-level vectors in a manner similar to action/page level encoder 602. For example, in some embodiments, session-level encoder 606 utilizes a bidirectional gated recurrent unit (GRU) based sequence encoder to get annotations of action/page level vectors (of amount L) by summarizing information from both directions of action/page level vectors, and therefore, incorporate the contextual information in the annotation, as follows:

$${\vec{h}}_{i} = \vec{\text{GRU}} \left({s}_{i}\right) , i ∈ \left[1 , T\right] ,$$

$${\overleftarrow{h}}_{i} = \overleftarrow{\text{GRU}} \left({s}_{i}\right) , i ∈ \left[1 , T\right] ,$$

Further, h̅ᵢ and h̅ᵢ are concatenated to get an annotation of the session. As such, hᵢ = [h̅ᵢ, h̅ᵢ], where hᵢ summarizes the neighbor sessions around session i but still focuses on session i.

As also shown in FIG. 6, in some embodiments HAN 600 contains session-level attention 608 that extracts important action/page level vectors and aggregates the representation of the informative action/page level vectors to form a session-level vector (v) that summarizes all the information of analytics data in sessions of the given session as given:

$${u}_{i} = tanh \left({W}_{s} {h}_{i} + {b}_{s}\right) ,$$

$${α}_{i} = \frac{exp \left({u}_{i}^{} {u}_{s}\right)}{{\sum }_{t} exp \left({u}_{i}^{} {u}_{s}\right)} ,$$

$$v = {\sum }_{i} {α}_{i} {h}_{i} .$$

The session-level vector is a high-level representation of the activities of a session that can further be used as features for session classification by using p = softmax(W_{c}v + b_{c}). The negative log likelihood of the correct labels can further be used as training loss, L = - Σ_{d} log(p_{dj}), where j is the label of session d.

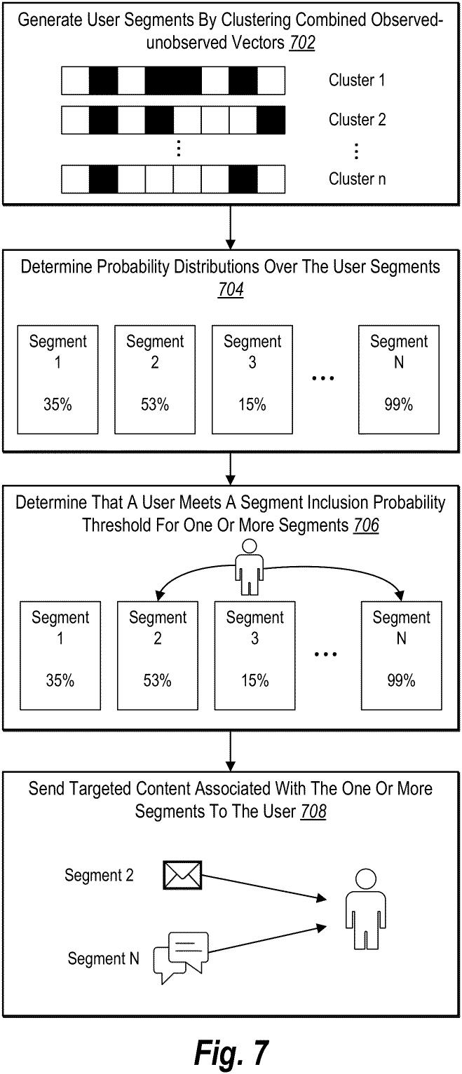

Turning now to FIG. 7, additional detail is provided regarding including users in more than one user segment (e.g., mixed targeting). In particular, FIG. 7 illustrates a general process of determining that a user meets a probability threshold for more than one segment and sending the user targeted content associated with multiple segments.

As shown in FIG. 7, the unobserved behavior segmentation and targeting system 104 performs act 702 and generates user segments by clustering combined observed-unobserved representations. For example, the unobserved behavior segmentation and targeting system 104 clusters the combined observed-unobserved representations by partitioning the representations into clusters in which each representations belongs to a cluster with the nearest mean (e.g., k means clustering). Additional detail about clustering combined observed-unobserved representations is provided in the description for FIG. 5.

As further illustrated in FIG. 7, the unobserved behavior segmentation and targeting system 104 performs act 704 to determine probability distributions over the user segments. For example, the unobserved behavior segmentation and targeting system 104 utilizes a neural network selector to determine probability distributions over the user segments. Additional detail about generating probability distributions over the user segments is provided in the description for FIG. 5.

As further illustrated in FIG. 7, the unobserved behavior segmentation and targeting system 104 performs act 706 and determines that a user meets a segment inclusion probability threshold for one or more segments. For example, the unobserved behavior segmentation and targeting system 104 determines that the probability of one or more user segments meets a segment inclusion probability threshold denoting a likelihood that the user is included in two or more segments. In some embodiments, the segment inclusion probability threshold is when the probability of a user segment constitutes a score or classification above a certain number or percentage (e.g., above 0.53). In other embodiments, the segment inclusion probability threshold is meet when a decision tree answers “yes” to questions regarding whether there is a likelihood that the user is included in the user segments.

As further included in FIG. 7, the unobserved behavior segmentation and targeting system 104 performs act 708 to send targeted content associated with the one or more segments to the user. Specifically, the unobserved behavior segmentation and targeting system 104 sends a user targeted content associated with each user segment that is above a segment probability inclusion threshold. Importantly, in some embodiments the unobserved behavior segmentation and targeting system 104 sends the user targeted content associated with each user segment that meets the segment inclusion probability threshold. As illustrated in FIG. 7, the unobserved behavior segmentation and targeting system 104 can send targeted content associated with segment 2 and segment N, as they both meet the segment inclusion probability threshold.

The unobserved behavior segmentation and targeting system 104 sends targeted content in a multitude of ways. For example, in some embodiments, the unobserved behavior segmentation and targeting system 104 sends targeted content to a user via email, direct message or other direct contact. In other embodiments, the unobserved behavior segmentation and targeting system 104 can send targeted content through a network system, such as through notification in a digital system.

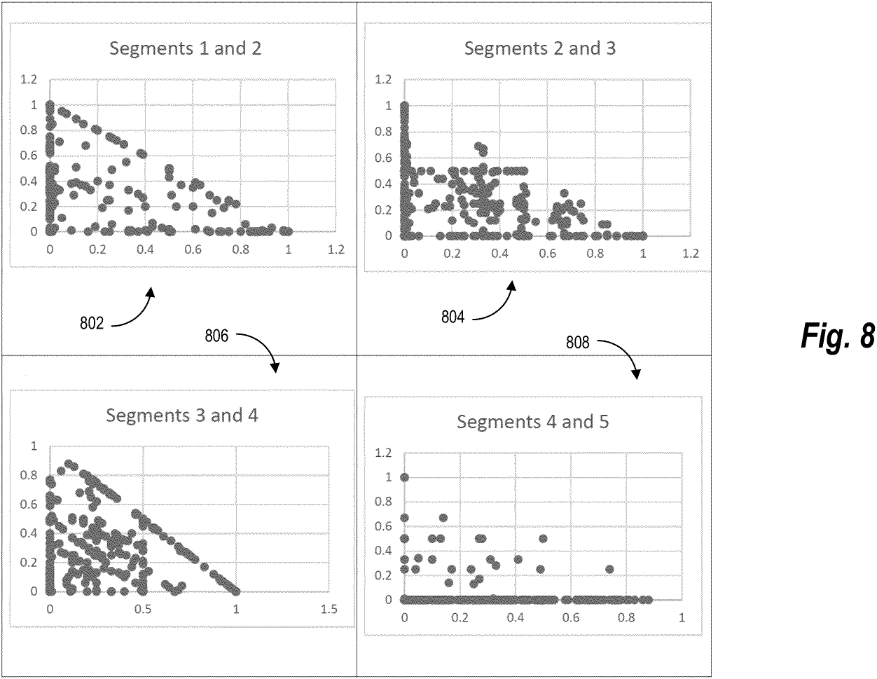

Turning now to FIG. 8, additional detail is provided regarding a user belonging to two or more segments. Specifically, FIG. 8 illustrates example probabilities for a user belonging to multiple segments when accounting for unobserved behaviors. For example, as shown in FIG. 8, for a sufficiently high segment inclusion probability threshold (e.g., >0.25) many users have probabilities that meet the high segment inclusion probability threshold. For example, as shown in 804, many users in segments 2 and 3 are above 0.25 and therefore meet the segment inclusion probability threshold. As further shown in 806, there are also a significant number of users above 0.25 in segments 3 and 4, that also meet the segment inclusion probability threshold. When significant numbers of users that meet the segment inclusion probability threshold, the unobserved behavior segmentation and targeting system 104 will send targeted content to the users in those user segments. In contrast, as shown in 802 and 808, a small number of users that are above 0.25. In those cases, the unobserved behavior segmentation and targeting system 104 will likely not send targeted content to those users.

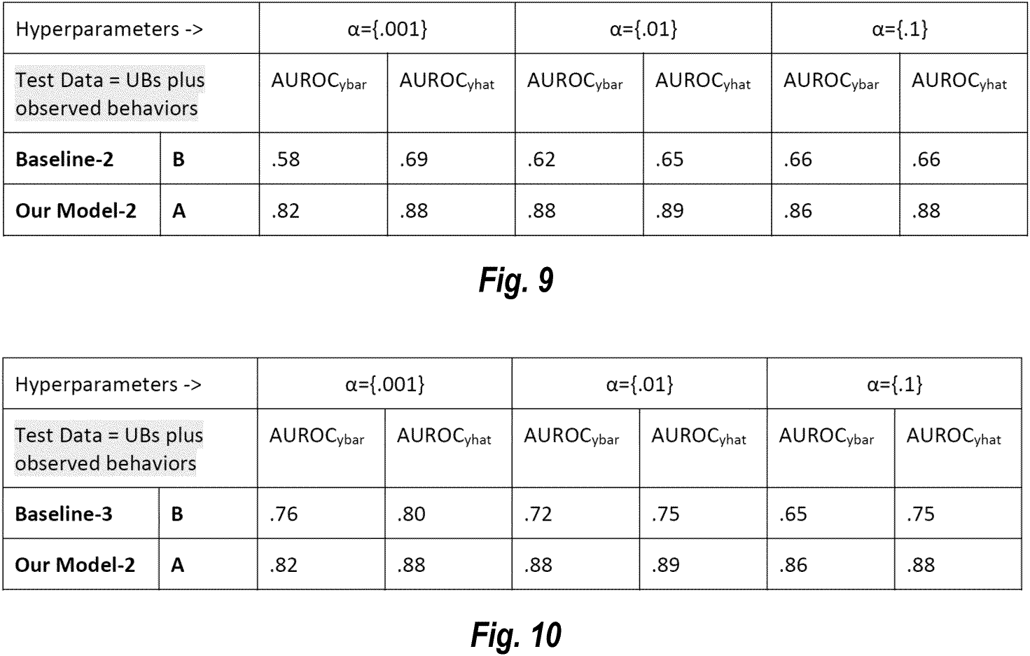

Turning now to FIGS. 9 & 10, additional detail is provided regarding example performance of the unobserved behavior segmentation and targeting system 104 compared to conventional systems. Specifically, FIG. 9 illustrates predictive performance of the unobserved behavior segmentation and targeting system 104 compared to conventional systems. FIG. 10 illustrates the unobserved behavior segmentation and targeting system 104 compared to conventions systems, but with boosting applied.

As illustrated in FIG. 9, the unobserved behavior segmentation and targeting system 104 shows an improvement over conventional systems. Specifically, utilizing an Area Under the Receiver Operating Characteristic Curve (AUROC), the unobserved behavior segmentation and targeting system 104 shows an improvement over the baseline (e.g., conventional system).

As also illustrated in FIG. 10, the unobserved behavior segmentation and targeting system 104 shows improvement over conventional systems when boosting is considered. Specifically, when boosting is considered, the baseline (e.g., conventional system) shows an improvement in the AUROC, but the unobserved behavior segmentation and targeting system 104 still shows a greater improvement.

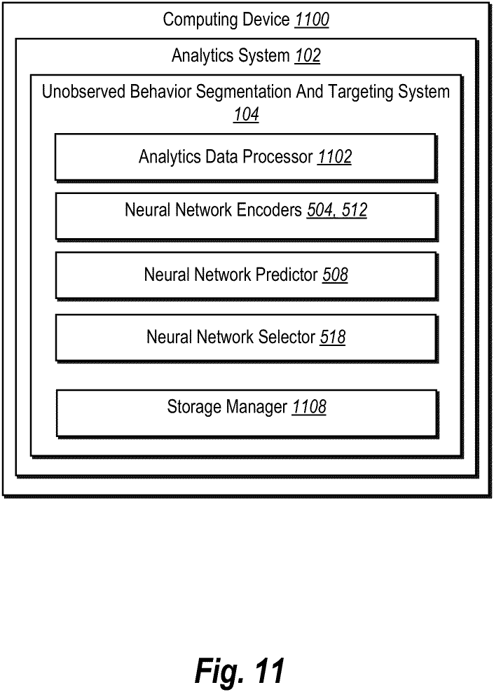

Looking now to FIG. 11, additional detail will be provided regarding components and capabilities of the unobserved behavior segmentation and targeting system 104. Specifically, FIG. 11 illustrates an example schematic diagram of the unobserved behavior segmentation and targeting system 104 on an example computing device 1100. As shown in FIG. 11, the unobserved behavior segmentation and targeting system 104 may include an analytics data processor 1102, neural network encoders 504, 512, neural network predictor 508, neural network selector 518, and a storage manager 1108. The storage manager 1108 can include one or more memory devices that store various data including analytics data, user segments, etc.

As just mentioned, the unobserved behavior segmentation and targeting system 104 includes an analytics data processor 1102. In particular, the analytics data processor 1102 manages, receives, provides, detects, determines, recognizes, logs, organizes, or otherwise processes analytics data. For example, the analytics data processor 1102 performs the acts described above in relation to FIGS. 3 and 4 to access analytics data, determine observed analytics data, and generate unobserved analytics data.

As also mentioned, the unobserved behavior segmentation and targeting system 104 includes the neural network encoders 504, 512. The neural network encoders 504, 512 generate embeddings from observed and unobserved analytics data as described above in relation to FIG. 5. Along related lines, the neural network selector 518 generates a probability distribution across a number of user segments or clusters of embeddings. As illustrated, the unobserved behavior segmentation and targeting system 104 further includes the neural network predictor 508. In particular, neural network predictor 508 generates predictions form embedding as described above in relation to FIG. 5.

In one or more embodiments, each of the components of the unobserved behavior segmentation and targeting system 104 are in communication with one another using any suitable communication technologies. Additionally, the components of the unobserved behavior segmentation and targeting system 104 can be in communication with one or more other devices including one or more client devices described above. It will be recognized that although the components of the unobserved behavior segmentation and targeting system 104 are shown to be separate in FIG. 11, any of the subcomponents may be combined into fewer components, such as into a single component, or divided into more components as may serve a particular implementation. Furthermore, although the components of FIG. 11 are described in connection with the unobserved behavior segmentation and targeting system 104, at least some of the components for performing operations in conjunction with the unobserved behavior segmentation and targeting system 104 described herein may be implemented on other devices within the environment.

The components of the unobserved behavior segmentation and targeting system 104 can include software, hardware, or both. For example, the components of the unobserved behavior segmentation and targeting system 104 can include one or more instructions stored on a computer-readable storage medium and executable by processors of one or more computing devices (e.g., the computing device 1100). When executed by the one or more processors, the computer-executable instructions of the unobserved behavior segmentation and targeting system 104 can cause the computing device 1100 to perform the methods described herein. Alternatively, the components of the unobserved behavior segmentation and targeting system 104 can comprise hardware, such as a special purpose processing device to perform a certain function or group of functions. Additionally, or alternatively, the components of the unobserved behavior segmentation and targeting system 104 can include a combination of computer-executable instructions and hardware.

Furthermore, the components of the unobserved behavior segmentation and targeting system 104 performing the functions described herein may, for example, be implemented as part of a stand-alone application, as a module of an application, as a plug-in for applications including content management applications, as a library function or functions that may be called by other applications, and/or as a cloud-computing model. Thus, the components of the unobserved behavior segmentation and targeting system 104 may be implemented as part of a stand-alone application on a personal computing device or a mobile device. Alternatively, or additionally, the components of the unobserved behavior segmentation and targeting system 104 may be implemented in any application that allows creation and delivery of marketing content to users, including, but not limited to, applications in ADOBE EXPERIENCE CLOUD, ADOBE ANALYTICS CLOUD, ADOBE DOCUMENT CLOUD, ADOBE CREATIVE CLOUD, and ADOBE MARKETING CLOUD, such as ADOBE AXLE, ADOBE ANALYTICS, and ADOBE TARGET. “ADOBE,” “ADOBE EXPERIENCE CLOUD,” “ADOBE ANALYTICS CLOUD,” “ADOBE MARKETING CLOUD,” “ADOBE DOCUMENT CLOUD,” “ADOBE CREATIVE CLOUD,” “ADOBE AXLE,” “ADOBE ANALYTICS,” and “ADOBE TARGET” are trademarks of Adobe Inc. in the United States and/or other countries.

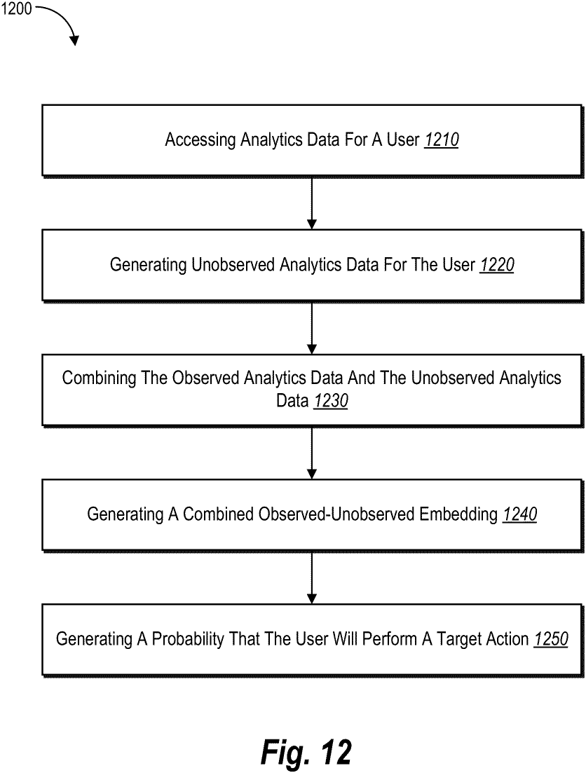

FIGS. 1-11, the corresponding text, and the examples provide a number of different methods, systems, devices, and non-transitory computer-readable media of the unobserved behavior segmentation and targeting system 104. In addition to the foregoing, one or more embodiments can also be described in terms of flowcharts comprising acts for accomplishing a particular result, as shown in FIGS. 12-14. While FIGS. 12-14 illustrate acts according to particular embodiments, alternative embodiments may omit, add to, reorder, and/or modify any of the acts shown in FIGS. 12-14. The acts of FIGS. 12-14 can be performed as part of a method. Alternatively, a non-transitory computer readable medium can comprise instructions, that when executed by one or more processors, cause the one or more processor to perform the acts of FIGS. 12-14. In still further embodiments, a system can be configured or programmed to perform the acts of FIGS. 12-14. Additionally, the acts described herein may be repeated or performed in parallel with one another or in parallel with different instances of the same or other similar acts.

FIG. 12 illustrates an example series of acts 1200 for incorporating unobserved behaviors when predicting whether a user will perform a target action. In one or more embodiments, the series of acts 1200 is implemented on one or more computing devices, such as the computing device 1100 or the server device 101. In addition, in some embodiments, the series of acts 1200 is implemented in a digital environment, such as a digital medium environment for generating segments or targeting users. The series of acts 1200 includes an act 1210 of accessing observed analytics data for a user. In particular, the act 1210 includes generating sequences of observed attributes or behaviors from observed analytics data for the user.

The series of acts 1200 also includes an act 1220 of generating unobserved analytics data for a user. For example, the act 1220 includes generating unobserved analytics data by determining a subset of attributes or behaviors that has an observation rate in the observed analytics data below a threshold observation rate. Act 1220 also includes sampling one or more attributes or behaviors from the subset of attributes or behaviors with a threshold similarity to observed attributes or behaviors from the observed analytics data. In additional embodiments, the act 1220 includes generating unobserved analytics data for a plurality of users.

The series of acts 1200 further includes an act 1230 of combining the observed analytics data and the unobserved analytics data. For example, the act 1230 includes combining the observed analytics data and the unobserved analytics data into a combined observed-unobserved vector. Specifically, the act 1230 includes, in one or more implementations, combining the observed analytics data and the unobserved analytics data into the combined observed-unobserved vector by generating a sequence of observed attributes or behaviors from the observed analytics data and inserting the unobserved analytics data in empty spaces in the sequence of observed attributes or behaviors. The act 1230 includes, in one or more implementations, combining the observed analytics data and the unobserved analytics data into the combined observed-unobserved vector by generating a sequence of observed attributes or behaviors from the observed analytics data and inserting the unobserved analytics data randomly in-between observed attributes or behaviors in the sequence of observed attributes or behaviors. Further, the act 1230 includes, in one or more implementations, combining the observed analytics data and the unobserved analytics data into the combined observed-unobserved vector by generating a sequence of observed attributes or behaviors from the observed analytics data and replacing one or more attributes or behaviors in the sequence of observed attributes or behaviors with the unobserved analytics data. In still further embodiments, the act 1230 includes generating combined observed-unobserved vectors by injecting unobserved attributes or behaviors into the sequences of observed attributes or behaviors.

The series of acts 1200 further includes an act 1240 of generating a combined observed-unobserved embedding. For example, act 1240 includes generating, utilizing a neural network encoder, a combined observed-unobserved embedding form the combined observed-unobserved vector. The combined observed-unobserved embedding encodes the observed and unobserved analytics date for the user. Specifically, the act 1240 includes, in one or more implementations, generating, utilizing the neural network encoder, the combined observed-unobserved embedding by generating, utilizing a first level of attention, action/page level embeddings. Additionally, the act 1240 includes, in one or more implementations, generating, utilizing the neural network encoder, the combined observed-unobserved embedding by generating, utilizing a second level of attention, session-level embeddings.

The series of acts 1200 further includes an act 1250 of generating a probability that the user will perform a target action. For example, the act 1250 includes generating, utilizing a neural network predictor, a probability, from the combined observed-unobserved embedding, that the user will perform a target action.

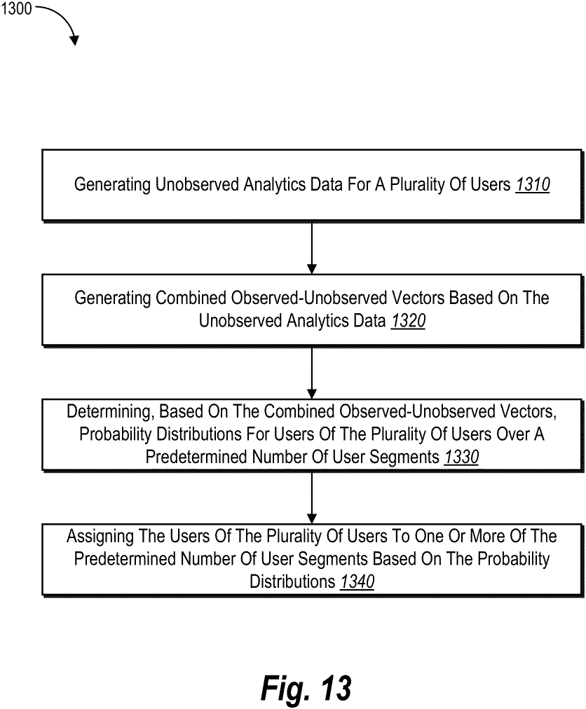

FIG. 13 illustrates an example series of acts 1300 for incorporating unobserved behaviors when predicting generating user segments. In one or more embodiments, the series of acts 1300 is implemented on one or more computing devices, such as the computing device 1100 or the server device 101. In addition, in some embodiments, the series of acts 1300 is implemented in a digital environment, such as a digital medium environment for generating segments or targeting users. The series of acts 1300 includes an act 1310 of generating unobserved analytics data for a plurality of users. Act 1310 involves, in one or more implementations, accessing observed analytics data for the plurality of users. In particular, the act 1310 includes generating sequences of observed attributes or behaviors from observed analytics data for the plurality of users. Still further, in one or more implementations, act 1310 involves generating unobserved analytics data by determining a subset of attributes or behaviors that has an observation rate in the observed analytics data below a threshold observation rate. Act 1310 also includes sampling one or more attributes or behaviors from the subset of attributes or behaviors with a threshold similarity to observed attributes or behaviors from the observed analytics data.

In still further implementations, act 1310 involves combining the observed analytics data and the unobserved analytics data. For instance, the act 1310 includes generating combined observed-unobserved vectors by injecting unobserved attributes or behaviors into sequences of observed attributes or behaviors. For example, the act 1310 includes combining the observed analytics data and the unobserved analytics data into combined observed-unobserved vectors. Specifically, the act 1310 includes, in one or more implementations, combining the observed analytics data and the unobserved analytics data into the combined observed-unobserved vectors by generating sequences of observed attributes or behaviors from the observed analytics data and inserting the unobserved analytics data in empty spaces in the sequences of observed attributes or behaviors. The act 1310 includes, in one or more implementations, combining the observed analytics data and the unobserved analytics data into the combined observed-unobserved vector by generating sequences of observed attributes or behaviors from the observed analytics data and inserting the unobserved analytics data randomly in-between observed attributes or behaviors in the sequences of observed attributes or behaviors. Further, the act 1310 includes, in one or more implementations, combining the observed analytics data and the unobserved analytics data into the combined observed-unobserved vector by generating sequences of observed attributes or behaviors from the observed analytics data and replacing one or more attributes or behaviors in the sequences of observed attributes or behaviors with the unobserved analytics data.

The series of acts 1300 further includes an act 1320 of generating, utilizing a neural network encoder, combined observed-unobserved vectors based on the unobserved analytics data. For example, act 1320 includes generating, utilizing the neural network encoder, combined observed-unobserved vectors from observed analytics data and the unobserved analytics data for the plurality of users. The combined observed-unobserved vectors encode observed and unobserved attributes or behaviors of the plurality of users. Specifically, the act 1240 includes, in one or more implementations, generating, utilizing the neural network encoder, the combined observed-unobserved embedding by generating, utilizing a first level of attention, action/page level embeddings. Additionally, the act 1320 includes, in one or more implementations, generating, utilizing the neural network encoder, the combined observed-unobserved embedding by generating, utilizing a second level of attention, session-level embeddings.

The series of acts 1300 further includes an act 1330 of determining, based on the combined observed-unobserved vectors, probability distributions for users of the plurality of users over a predetermined number of user segments. For example, act 1330 involves determining, utilizing a neural network selector and based on the combined observed-unobserved vectors, probability distributions for users of the plurality of users over a predetermined number of user segments.

The series of acts 1300 further includes an act 1340 of assigning the users of the plurality of users to one or more of the predetermined number of user segments based on the probability distributions. For example, act 1340 involves determining that a first probability from the probability distributions for a first user and a first user segment meets a probability threshold indicating that the first user belongs to the first user segment. Additionally, act 1340 involves, in one or more implementations, determining that a second probability from the probability distributions for the first user and a second user segment meets a segment inclusion probability threshold, indicating that the first user belongs to the second user segment. Act 1340 further involves including the first user in both the first user segment and the second user segment based on the first probability and the second probability meeting the segment inclusion probability threshold.

The series of acts 1300 optionally further includes generating, utilizing a neural network predictor, a segment probability that users from a first user segment will perform a target action. For example, the series of acts 1300 involves determining an embedding of a centroid of the first user segment utilizing an embedding dictionary. The series of acts 1300 further includes predicting a target label indicating whether the first user segment will perform the target action by processing the embedding of the centroid of the first user segment utilizing the neural network predictor.

The series of acts 1300 optionally further includes generating, utilizing the neural network predictor, a user probability that a first user from the first user segment will perform the target action. For example, the series of acts 1300 predicting a target label indicating whether the first user will perform the target action by processing a combined observed-unobserved vector for the first user utilizing the neural network predictor. The series of acts 1300 optionally further includes sending targeted content to one more of the first user or the first user segment based on the user probability and the segment probability.

Furthermore, in one or more embodiments, the series of acts 1300 include generating, utilizing a neural network predictor, a first segment probability, from an embedding of the centroid of the first user segment. The first segment probability indicates whether users in the first user segment will perform a target action. The series of acts 1300 also include, generating, utilizing the neural network predictor, a second segment probability, from an embedding of a centroid of the second user segment. The second segment probability indicates whether users in the second user segment will perform the target action. The series of acts 1300 also include determining that the first segment probability and the second segment probability satisfy a targeting probability threshold. The series of acts 1300 also include sending first targeted content to the users in the first user segment and sending second targeted content to the users in the second user segment. The users in the first user segment include the first user and users in the second user segment include the first user.

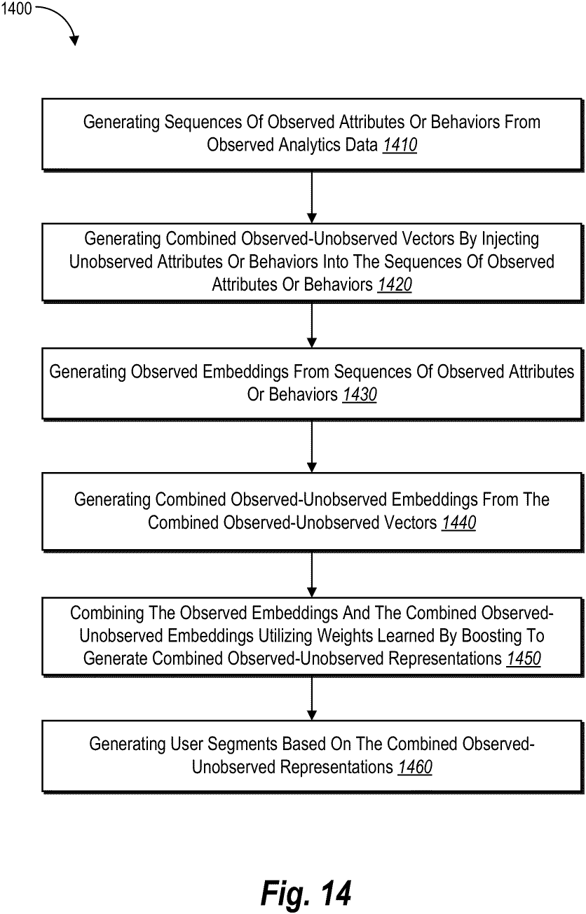

FIG. 14 illustrates an example series of acts 1400 of incorporating unobserved behaviors when predicting generating user segments. In one or more embodiments, the series of acts 1400 is implemented on one or more computing devices, such as the computing device 1100 or the server device 101. In addition, in some embodiments, the series of acts 1400 is implemented in a digital environment, such as a digital medium environment for generating segments or targeting users. The series of acts 1400 includes an act 1410 of generating sequences of observed attributes or behaviors from observed analytics data. The series of acts 1400 includes an act 1420 of generating combined observed-unobserved vectors by injecting unobserved attributes or behaviors into the sequences of observed attributes or behaviors.

The series of acts 1400 includes an act 1430 of generating, utilizing a first neural network encoder, observed embeddings from sequences of observed attributes or behaviors. The series of acts 1400 includes an act 1440 of generating, utilizing a second neural network encoder, combined observed-unobserved embeddings from the combined observed-unobserved vectors.

The series of acts 1400 includes an act 1450 of combining the observed embeddings and the combined observed-unobserved embeddings utilizing weights learned by boosting to generate combined observed-unobserved representations. For example, the act 1450 includes learning the weights utilizing boosting by learning a weight for observed sequences and a weight for combined observed-unobserved sequences. For instance, learning a weight for observed sequences includes generating, utilizing the first neural network encoder and a neural network predictor, a first set of predicted outputs from training sequences of observed attributes or behaviors. Act 1450 further involves determining an observed mean loss based on the first set of predicted outputs and generating the weight for observed sequences based on the observed mean loss. In one or more implementations, act 1450 further involves initializing the user segments by clustering the combined observed-unobserved representations.

In one or more implementations act 1450, involves learning the weight for combined observed-unobserved sequences by generating, utilizing the second neural network encoder and a neural network predictor, a second set of predicted outputs from training combined observed-unobserved vectors. For instance, act 1450 involves determining a combined mean loss based on the second set of predicted outputs and generating the weight for combined observed-unobserved sequences based on the combined mean loss.

Moreover, in one or more implementations, act 1450 involves combining the observed embeddings and the unobserved embeddings by weighting the observed embeddings by the weight for observed sequences, weighting the combined observed-unobserved embeddings by the weight for combined observed-unobserved sequences, and summing the weighted observed embeddings and the weighted combined observed-unobserved embeddings.

The series of acts 1400 includes an act 1450 of generating user segments based on the combined observed-unobserved representation. For example, the series of acts 1400, in one or more implementations, involves determining probability distributions over the user segments for users of the plurality of users utilizing a neural network selector. Additionally, the series of acts 1400 includes sampling the user segments based on an entropy of the probability distributions. The series of acts 1400 also involves mapping the sampled user segments to centroid embeddings. The series of acts 1400 also involves generating, from the centroid embeddings and utilizing a neural network predictor, a target action probabilities that users from the user segments will perform a target action.

In one or more embodiments, the acts 1400 involves learning parameters for one or more of the first and second neural network encoders, the neural network selector, or the neural network predictor. Specifically, learning parameters involves determining a separation loss denoting that the user segments are within a threshold distance, determining a user segment loss based on clustering the combined observed-unobserved representations, and summing the separation loss and the user segment loss. More specifically, learning parameters can include determining a mean centroid loss for the centroid embeddings and determining that the mean centroid loss is above a mean centroid threshold.

Embodiments of the present disclosure may comprise or utilize a special purpose or general-purpose computer including computer hardware, such as, for example, one or more processors and system memory, as discussed in greater detail below. Embodiments within the scope of the present disclosure also include physical and other computer-readable media for carrying or storing computer-executable instructions and/or data structures. In particular, one or more of the processes described herein may be implemented at least in part as instructions embodied in a non-transitory computer-readable medium and executable by one or more computing devices (e.g., any of the media content access devices described herein). In general, a processor (e.g., a microprocessor) receives instructions, from a non-transitory computer-readable medium, (e.g., memory), and executes those instructions, thereby performing one or more processes, including one or more of the processes described herein.

Computer-readable media can be any available media that can be accessed by a general purpose or special purpose computer system. Computer-readable media that store computer-executable instructions are non-transitory computer-readable storage media (devices). Computer-readable media that carry computer-executable instructions are transmission media. Thus, by way of example, and not limitation, embodiments of the disclosure can comprise at least two distinctly different kinds of computer-readable media: non-transitory computer-readable storage media (devices) and transmission media.

Non-transitory computer-readable storage media (devices) includes RAM, ROM, EEPROM, CD-ROM, solid state drives (“SSDs”) (e.g., based on RAM), Flash memory, phase-change memory (“PCM”), other types of memory, other optical disk storage, magnetic disk storage or other magnetic storage devices, or any other medium which can be used to store desired program code means in the form of computer-executable instructions or data structures and which can be accessed by a general purpose or special purpose computer.

A “network” is defined as one or more data links that enable the transport of electronic data between computer systems and/or modules and/or other electronic devices. When information is transferred or provided over a network or another communications connection (either hardwired, wireless, or a combination of hardwired or wireless) to a computer, the computer properly views the connection as a transmission medium. Transmissions media can include a network and/or data links which can be used to carry desired program code means in the form of computer-executable instructions or data structures and which can be accessed by a general purpose or special purpose computer. Combinations of the above should also be included within the scope of computer-readable media.

Further, upon reaching various computer system components, program code means in the form of computer-executable instructions or data structures can be transferred automatically from transmission media to non-transitory computer-readable storage media (devices) (or vice versa). For example, computer-executable instructions or data structures received over a network or data link can be buffered in RAM within a network interface module (e.g., a “NIC”), and then eventually transferred to computer system RAM and/or to less volatile computer storage media (devices) at a computer system. Thus, it should be understood that non-transitory computer-readable storage media (devices) can be included in computer system components that also (or even primarily) utilize transmission media.

Computer-executable instructions comprise, for example, instructions and data which, when executed by a processor, cause a general-purpose computer, special purpose computer, or special purpose processing device to perform a certain function or group of functions. In some embodiments, computer-executable instructions are executed by a general-purpose computer to turn the general-purpose computer into a special purpose computer implementing elements of the disclosure. The computer-executable instructions may be, for example, binaries, intermediate format instructions such as assembly language, or even source code. Although the subject matter has been described in language specific to structural features and/or methodological acts, it is to be understood that the subject matter defined in the appended claims is not necessarily limited to the described features or acts described above. Rather, the described features and acts are disclosed as example forms of implementing the claims.

Those skilled in the art will appreciate that the disclosure may be practiced in network computing environments with many types of computer system configurations, including, personal computers, desktop computers, laptop computers, message processors, hand-held devices, multiprocessor systems, microprocessor-based or programmable consumer electronics, network PCs, minicomputers, mainframe computers, mobile telephones, PDAs, tablets, pagers, routers, switches, and the like. The disclosure may also be practiced in distributed system environments where local and remote computer systems, which are linked (either by hardwired data links, wireless data links, or by a combination of hardwired and wireless data links) through a network, both perform tasks. In a distributed system environment, program modules may be located in both local and remote memory storage devices.

Embodiments of the present disclosure can also be implemented in cloud computing environments. As used herein, the term “cloud computing” refers to a model for enabling on-demand network access to a shared pool of configurable computing resources. For example, cloud computing can be employed in the marketplace to offer ubiquitous and convenient on-demand access to the shared pool of configurable computing resources. The shared pool of configurable computing resources can be rapidly provisioned via virtualization and released with low management effort or service provider interaction, and then scaled accordingly.

A cloud-computing model can be composed of various characteristics such as, for example, on-demand self-service, broad network access, resource pooling, rapid elasticity, measured service, and so forth. A cloud-computing model can also expose various service models, such as, for example, Software as a Service (“SaaS”), Platform as a Service (“PaaS”), and Infrastructure as a Service (“IaaS”). A cloud-computing model can also be deployed using different deployment models such as private cloud, community cloud, public cloud, hybrid cloud, and so forth. In addition, as used herein, the term “cloud-computing environment” refers to an environment in which cloud computing is employed.

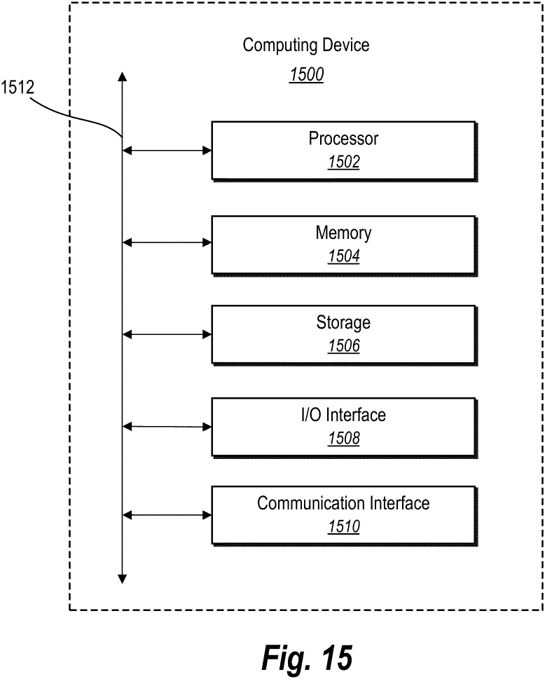

FIG. 15 illustrates a block diagram of an example computing device 1500 that may be configured to perform one or more of the processes described above. One will appreciate that one or more computing devices, such as the computing device 1500 may represent the computing devices described above (e.g., computing device 1100, server device 101, 108, administrator client device 114, and user client devices 110a-110n). In one or more embodiments, the computing device 1500 may be a mobile device (e.g., a mobile telephone, a smartphone, a PDA, a tablet, a laptop, a camera, a tracker, a watch, a wearable device, etc.). In some embodiments, the computing device 1500 may be a non-mobile device (e.g., a desktop computer or another type of client device). Further, the computing device 1500 may be a server device that includes cloud-based processing and storage capabilities.

As shown in FIG. 15, the computing device 1500 can include one or more processor(s) 1502, memory 1504, a storage device 1506, input/output interfaces 1508 (or “I/O interfaces 1508”), and a communication interface 1510, which may be communicatively coupled by way of a communication infrastructure (e.g., bus 1512). While the computing device 1500 is shown in FIG. 15, the components illustrated in FIG. 15 are not intended to be limiting. Additional or alternative components may be used in other embodiments. Furthermore, in certain embodiments, the computing device 1500 includes fewer components than those shown in FIG. 15. Components of the computing device 1500 shown in FIG. 15 will now be described in additional detail.

In particular embodiments, the processor(s) 1502 includes hardware for executing instructions, such as those making up a computer program. As an example, and not by way of limitation, to execute instructions, the processor(s) 1502 may retrieve (or fetch) the instructions from an internal register, an internal cache, memory 1504, or a storage device 1506 and decode and execute them.

The computing device 1500 includes memory 1504, which is coupled to the processor(s) 1502. The memory 1504 may be used for storing data, metadata, and programs for execution by the processor(s). The memory 1504 may include one or more of volatile and nonvolatile memories, such as Random-Access Memory (“RAM”), Read-Only Memory (“ROM”), a solid-state disk (“SSD”), Flash, Phase Change Memory (“PCM”), or other types of data storage. The memory 1504 may be internal or distributed memory.

The computing device 1500 includes a storage device 1506 includes storage for storing data or instructions. As an example, and not by way of limitation, the storage device 1506 can include a non-transitory storage medium described above. The storage device 1506 may include a hard disk drive (HDD), flash memory, a Universal Serial Bus (USB) drive or a combination these or other storage devices.

As shown, the computing device 1500 includes one or more I/O interfaces 1508, which are provided to allow a user to provide input to (such as user strokes), receive output from, and otherwise transfer data to and from the computing device 1500. These I/O interfaces 1508 may include a mouse, keypad or a keyboard, a touch screen, camera, optical scanner, network interface, modem, other known I/O devices or a combination of such I/O interfaces 1508. The touch screen may be activated with a stylus or a finger.

The I/O interfaces 1508 may include one or more devices for presenting output to a user, including, but not limited to, a graphics engine, a display (e.g., a display screen), one or more output drivers (e.g., display drivers), one or more audio speakers, and one or more audio drivers. In certain embodiments, I/O interfaces 1508 are configured to provide graphical data to a display for presentation to a user. The graphical data may be representative of one or more graphical user interfaces and/or any other graphical content as may serve a particular implementation.

The computing device 1500 can further include a communication interface 1510. The communication interface 1510 can include hardware, software, or both. The communication interface 1510 provides one or more interfaces for communication (such as, for example, packet-based communication) between the computing device and one or more other computing devices or one or more networks. As an example, and not by way of limitation, communication interface 1510 may include a network interface controller (NIC) or network adapter for communicating with an Ethernet or other wire-based network or a wireless NIC (WNIC) or wireless adapter for communicating with a wireless network, such as a WI-FI. The computing device 1500 can further include a bus 1512. The bus 1512 can include hardware, software, or both that connects components of computing device 1500 to each other.

In the foregoing specification, the invention has been described with reference to specific example embodiments thereof. Various embodiments and aspects of the invention(s) are described with reference to details discussed herein, and the accompanying drawings illustrate the various embodiments. The description above and drawings are illustrative of the invention and are not to be construed as limiting the invention. Numerous specific details are described to provide a thorough understanding of various embodiments of the present invention.

The present invention may be embodied in other specific forms without departing from its spirit or essential characteristics. The described embodiments are to be considered in all respects only as illustrative and not restrictive. For example, the methods described herein may be performed with less or more steps/acts or the steps/acts may be performed in differing orders. Additionally, the steps/acts described herein may be repeated or performed in parallel to one another or in parallel to different instances of the same or similar steps/acts. The scope of the invention is, therefore, indicated by the appended claims rather than by the foregoing description. All changes that come within the meaning and range of equivalency of the claims are to be embraced within their scope.

What is claimed is:

1. A method comprising:
accessing observed analytics data for a user;
generating unobserved analytics data for the user;
combining the observed analytics data and the unobserved analytics data into a combined observed-unobserved vector;
generating, utilizing a neural network encoder, a combined observed-unobserved embedding from the combined observed-unobserved vector, wherein the combined observed-unobserved embedding encodes the observed and unobserved analytics data for the user; and
generating, utilizing a neural network predictor, a probability, from the combined observed-unobserved embedding, that the user will perform a target action.

2. The method of claim 1, wherein generating unobserved analytics data for the user comprises:
determining a subset of attributes or behaviors that has an observation rate in the observed analytics data below a threshold observation rate; and
sampling one or more attributes or behaviors from the subset of attributes or behaviors with a threshold similarity to observed attributes or behaviors from the observed analytics data.

3. The method of claim 1, wherein combining the observed analytics data and the unobserved analytics data into the combined observed-unobserved vector comprises:
generating a sequence of observed attributes or behaviors from the observed analytics data; and
inserting the unobserved analytics data in empty spaces in the sequence of observed attributes or behaviors.

4. The method of claim 1, wherein combining the observed analytics data and the unobserved analytics data into the combined observed-unobserved vector comprises:
generating a sequence of observed attributes or behaviors from the observed analytics data; and
inserting the unobserved analytics data randomly in-between observed attributes or behaviors in the sequence of observed attributes or behaviors.

5. The method of claim 1, wherein combining the observed analytics data and the unobserved analytics data into the combined observed-unobserved vector comprises:
generating a sequence of observed attributes or behaviors from the observed analytics data; and
replacing one or more attributes or behaviors in the sequence of observed attributes or behaviors with the unobserved analytics data.

6. The method of claim 1 wherein generating, utilizing the neural network encoder, the combined observed-unobserved embedding comprises generating, utilizing a first level of attention of the neural network encoder, action/page level embeddings.

7. A non-transitory computer-readable medium storing instructions that, when executed by at least one processor, cause the at least one processor to perform operations comprising:
generating unobserved analytics data for a plurality of users;
generating, utilizing a neural network encoder, combined observed-unobserved vectors from observed analytics data and the unobserved analytics data for the plurality of users, wherein the combined observed-unobserved vectors encode both observed and unobserved attributes or behaviors of the plurality of users;
determining, utilizing a neural network selector and based on the combined observed-unobserved vectors, probability distributions for users of the plurality of users over a number of user segments; and
assigning the users of the plurality of users to one or more of the number of user segments based on the probability distributions.

8. The non-transitory computer-readable medium of claim 7, further comprising instructions that, when executed by the at least one processor, cause the at least one processor to generate, utilizing a neural network predictor, a segment probability that users from a first user segment will perform a target action.

9. The non-transitory computer-readable medium of claim 8, further comprising instructions that, when executed by the at least one processor, cause the at least one processor to:
determine that a first probability from the probability distributions for a first user and a first user segment meets a segment inclusion probability threshold indicating that the first user belongs to the first user segment; and
generate, utilizing the neural network predictor, a user probability that the first user from the first user segment will perform the target action.

10. The non-transitory computer-readable medium of claim 9, further comprising instructions that, when executed by the at least one processor, cause the at least one processor to send targeted content to one more of the first user or the first user segment based on the user probability and the segment probability.

11. The non-transitory computer-readable medium of claim 7, further comprising instructions that, when executed by the at least one processor, cause the at least one processor to:
determine that a first probability from the probability distributions for a first user and a first user segment meets a segment inclusion probability threshold;
determine that a second probability from the probability distributions for the first user and a second user segment meets a segment inclusion probability threshold; and
including the first user in both the first user segment and the second user segment based on the first probability and the second probability meeting the segment inclusion probability threshold.

12. The non-transitory computer-readable medium of claim 11, further comprising instructions that, when executed by the at least one processor, cause the at least one processor to:
generate, utilizing a neural network predictor, a first segment probability, from an embedding of a centroid of the first user segment, wherein the first segment probability indicates whether users in the first user segment will perform a target action;
generate, utilizing the neural network predictor, a second segment probability, from an embedding of a centroid of the second user segment, wherein the second segment probability indicates whether users in the second user segment will perform the target action;
determine that the first segment probability and the second segment probability satisfy a targeting probability threshold; and
send first targeted content to the users in the first user segment, wherein the users in the first user segment include the first user; and send second targeted content to the users in the second user segment, wherein the users in the second user segment include the first user.

13. The non-transitory computer-readable medium of claim 7, further comprising instructions that, when executed by the at least one processor, cause the at least one processor to learn the number of user segments through optimization.

14. A system comprising:
at least one memory device storing observed analytics data for a plurality of users; and
at least one processor configured to cause the system to:
generate sequences of observed attributes or behaviors from observed analytics data;
generate combined observed-unobserved vectors by injecting unobserved attributes or behaviors into the sequences of observed attributes or behaviors;
generate, utilizing a first neural network encoder, observed embeddings from the sequences of observed attributes or behaviors;
generate, utilizing a second neural network encoder, combined observed-unobserved embeddings from the combined observed-unobserved vectors;
combine the observed embeddings and the combined observed-unobserved embeddings utilizing weights learned by boosting to generate combined observed-unobserved representations; and
generate user segments based on the combined observed-unobserved representations.

15. The system as recited in claim 14, wherein the at least one processor is further configured to cause the system to learn the weights utilizing boosting by learning a weight for observed sequences and a weight for combined observed-unobserved sequences.

16. The system as recited in claim 15, wherein learning the weight for observed sequences comprises:
generating, utilizing the first neural network encoder and a neural network predictor, a first set of predicted outputs from training sequences of observed attributes or behaviors;
determining an observed mean loss based on the first set of predicted outputs; and
generating the weight for observed sequences based on the observed mean loss.

17. The system as recited in claim 15, wherein learning the weight for combined observed-unobserved sequences comprises:
generating, utilizing the second neural network encoder and a neural network predictor, a second set of predicted outputs from training combined observed-unobserved vectors;
determining a combined mean loss based on the second set of predicted outputs; and
generating the weight for combined observed-unobserved sequences based on the combined mean loss.

18. The system as recited in claim 17, wherein the at least one processor is further configured to cause the system to combine the observed embeddings and the combined observed-unobserved embeddings by:
weighting the observed embeddings by the weight for observed sequences;
weighting the combined observed-unobserved embeddings by the weight for combined observed-unobserved sequences; and
summing the weighted observed embeddings and the weighted combined observed-unobserved embeddings.

19. The system as recited in claim 14, wherein the at least one processor is further configured to:
determine, utilizing a neural network selector, probability distributions over the user segments;
sample the user segments based on an entropy of the probability distributions;
map the sampled user segments to centroid embeddings; and
generate, from the centroid embeddings utilizing a neural network predictor, target action probabilities that users from the user segments will perform a target action.

20. The system as recited in claim 19, wherein injecting unobserved attributes or behaviors into the sequences of observed attributes or behaviors comprises injecting unobserved attributes or behaviors into padding of the sequences of observed attributes or behaviors or interleaving the unobserved attributes or behaviors with the observed attributes or behaviors.
